(19) United States
(12) Patent Application Publication
(10) Pub. No.: US 2023/0379792 A1
(43) Pub. Date: Nov. 23, 2023

(54) REROUTING OF UL/DL TRAFFIC IN AN IAB NETWORK

(71) Applicant: Telefonaktiebolaget LM Ericsson (publ), Stockholm (SE)

(72) Inventors: Ajmal MUHAMMAD, Sollentuna (SE); Marco BELLESCHI, Solna (SE); Jose Luis PRADAS, Stockholm (SE)

(21) Appl. No.: 18/247,948

(22) PCT Filed: Oct. 22, 2021
(86) PCT No.: PCT/SE2021/051068

§ 371 Date: Apr. 5, 2023

Related U.S. Application Data
(60) Provisional application No. 63/094,977, filed on Oct. 22, 2020.

(51) Int. Cl. H04W 40/22; H04L 45/74; H04W 28/02

(52) U.S. Cl. CPC H04W 40/22; H04L 45/74; H04W 28/0289

(57) ABSTRACT

A method performed by a first donor distributed unit (DU) in an integrated access backhaul (IAB) network is provided. The method includes obtaining for each IAB node under the domain of each donor DU in the IAB network, a respective assigned IP address of the respective IAB node, receiving a rerouted packet, checking whether a source IP address of the rerouted packet matches an assigned IP address of an IAB node under the domain of the first donor DU, if the source IP address does not match an assigned IP address of an IAB node under the domain of the first donor DU, checking whether the source IP address of the rerouted packet matches an assigned IP address obtained by the donor DU, and if the source IP address matches an assigned IP address obtained the donor DU, forwarding the rerouted packet to an upper layer.

### TECHNICAL FIELD

Embodiments of the present disclosure relate to configuration of an integrated access backhaul (IAB) network, and particularly to methods performed by a donor distributed unit, a donor central unit, and an IAB node in the IAB network, apparatuses for performing such methods, as well as computer programs and computer program products comprising instructions for performing thereof.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Protocol and Architecture Overview of Integrated Access Backhaul (IAB) Networks

3rd Generation Partnership Project (3GPP) is currently standardizing integrated access and wireless access Backhaul in New Radio (NR) (IAB) in Rel-16 (RP-182882).

The usage of short range mmWave spectrum in NR creates a need for densified deployment with multi-hop backhauling. However, optical fiber to every base station would be too costly and sometimes not even possible (e.g. for historical sites). The main IAB principle is the use of wireless links for the backhaul (instead of fiber) to enable flexible and very dense deployment of cells without the need for densifying the transport network. Use case scenarios for IAB can include coverage extension, deployment of massive number of small cells and fixed wireless access (FWA) (e.g. to residential/office buildings). The larger bandwidth available for NR in mmWave spectrum provides the opportunity for self-backhauling, without limiting the spectrum to be used for the access links. On top of that, the inherent multi-beam and Multiple Input Multiple Output (MIMO) support in NR reduce cross-link interference between backhaul and access links, allowing higher densification.

During the study item phase of the IAB work (summary of the study item can be found in the technical report TR 38.874), it has been agreed to adopt a solution that leverages the central Unit (CU)/distributed Unit (DU) split architecture of NR, where the IAB node will be hosting a DU part that is controlled by a central unit. The IAB nodes also have a Mobile Termination (MT) part that they use to communicate with their parent nodes.

The specifications for IAB strive to reuse existing functions and interfaces defined in NR. In particular, MT, next generation node B distributed unit (gNB-DU), next generation node B central unit (gNB-CU), User Plane Function (UPF), Access and Mobility Function (AMF), and Session Management Function (SMF), as well as the corresponding interfaces NR Uu (between MT and next generation node B (gNB)), F1, NG, X2, and N4 are used as baseline for the IAB architectures. Modifications or enhancements to these functions and interfaces for the support of IAB will be explained in the context of the architecture discussion. Additional functionality such as multi-hop forwarding is included in the architecture discussion as it is necessary for the understanding of IAB operation and since certain aspects may require standardization.

The MT function has been defined as a component of the IAB node. In the context of this study, MT is referred to as a function residing on an IAB node that terminates the radio interface layers of the backhaul Uu interface toward the IAB donor or other IAB nodes.

FIG. 1 is a reference diagram for an IAB architecture. The diagram illustrates a high-level architectural view of an IAB network which shows IAB in standalone mode, which contains one IAB donor 110 and multiple IAB nodes 120-A, 120-B, 120-C, 120-D, and 120-D. The IAB donor 110 is treated as a single logical node that comprises a set of functions such as gNB-DU, gNB-CU-CP, gNB-CU-UP and potentially other functions. In a deployment, the IAB donor 110 can be split according to these functions, which can all be either collocated or non-collocated as allows by 3GPP NG-Radio Access Network (RAN) architecture. IAB-related aspects may arise when such split is exercised. Also, some of the functions presently associated with the IAB donor may eventually may be moved outside of the donor in case it becomes evident that they do not perform IAB-specific tasks.

FIG. 2 illustrates a baseline user plane (UP) protocol stack for IAB, and FIGS. 3A, 3B, and 3C illustrate a baseline control plane (CP) protocol stack for IAB.

As shown in FIG. 2 and FIGS. 3A-3C, the chosen protocol stacks reuse the CU-DU split specification in Rel-15, where the full user plane F1-U is terminated at the IAB node (like a normal DU) and the full control plane F1-C is also terminated at the IAB node (like a normal DU). In the above cases, Network Domain Security (NDS) has been employed to protect both UP and CP traffic (IPsec in the case of UP, and Datagram Transport Layer Security (DTLS) in the case of CP). IPsec could also be used for the CP protection instead of DTLS (in this case no DTLS layer would be used).

A new protocol layer called Backhaul Adaptation Protocol (BAP) has been introduced in the IAB nodes and the IAB donor, which is used for routing of packets to the appropriate downstream/upstream node and also mapping the user equipment (UE) bearer data to the proper backhaul Radio Link Control (RLC) channel (and also between ingress and egress backhaul RLC channels in intermediate IAB nodes) to satisfy the end-to-end Quality of Service (QoS) requirements of bearers.

Backhaul Adaptation Protocol (BAP) Entities

On the IAB node, the BAP sublayer contains one BAP entity at the MT function and a separate collocated BAP entity at the DU function as shown in FIG. 2, FIG. 3A, FIG. 3B, and FIG. 3C. On the donor DU, the BAP sublayer contains only one BAP entity. Each BAP entity has a transmitting part and a receiving part. The transmitting part of the BAP entity has a corresponding receiving part of a BAP entity at the IAB node or donor DU across the backhaul link.

Data Transfer—Transmitting Operation

The transmitting part of the BAP entity on the IAB-MT can receive BAP service data units (SDUs) from upper layers and BAP Data Packets from the receiving part of the BAP entity on the IAB-DU of the same IAB node, and construct BAP Data Protocol Data Units (PDUs) as needed. The transmitting part of the BAP entity on the IAB-DU can receive BAP Data Packets from the receiving part of the BAP entity on the IAB-MT of the same IAB node, and construct BAP Data PDUs as needed. The transmitting part of the BAP entity on the donor DU can receive BAP SDUs from upper layers.

Upon receiving a BAP SDU from upper layers, the transmitting part of the BAP entity shall:
select a BAP address and a BAP path identity for this BAP SDU;
construct a BAP Data PDU by adding a BAP header to the BAP SDU, where the DESTINATION field is set to the selected BAP address and the PATH field is set to the selected BAP path identity;

When the BAP entity has a BAP Data PDU to transmit, the transmitting part of the BAP entity shall:
perform routing to determine the egress link;
determine the egress backhaul (BH) RLC channel;
submit this BAP Data PDU to the selected egress BH RLC channel of the selected egress link.

Data buffering on the transmitting part of the BAP entity, e.g., until RLC-AM entity has received an acknowledgement, is up to implementation. In case of BH Radio Link Failure (RLF), the transmitting part of the BAP entity may reroute the BAP Data PDUs, which has not been acknowledged by lower layer before the BH RLF, to an alternative path.

BAP Routing Identity (ID) Selection at IAB Node

At an IAB node, for a BAP SDU received from upper layers and to be transmitted in upstream direction, the BAP entity performs mapping to a BAP address and BAP path identity based on:
Uplink Traffic to Routing ID Mapping Configuration, which is derived from F1AP on the IAB node in TS 38.473.

Each entry of the Uplink Traffic to Routing ID Mapping Configuration contains:
a traffic type specifier, which is indicated by uplink (UL) UP Transport Network Layer (TNL) Information IE for F1-U packets and Non-UP Traffic Type IE for non-F1-U packets in TS 38.473, and
a BAP routing ID, which includes a BAP address and a BAP path identity, indicated by BAP Routing ID IE in BH information IE in TS 38.473.

At the IAB node, for a BAP SDU received from upper layers and to be transmitted in upstream direction, the BAP entity shall:
if the defaultUL-BAP-routingID has been received in Radio Resource Control (RRC) and until the Uplink Traffic to Routing ID Mapping Configuration is (re)configured by F1AP:
   select the BAP address and the BAP path identity as configured by defaultUL-BAP-routingID in TS 38.331 for non-F1-U packets;
else:
   for the BAP SDU encapsulating an F1-U packet:
      select an entry from the Uplink Traffic to Routing ID Mapping Configuration with its traffic type specifier corresponds to the destination IP address and TEID of this BAP SDU;
   for the BAP SDU encapsulating a non-F1-U packet:
      select an entry from the Uplink Traffic to Routing ID Mapping Configuration with its traffic type specifier corresponds to the traffic type of this BAP SDU;
   select the BAP address and the BAP path identity from the BAP routing ID in the entry selected above;

Uplink Traffic to Routing ID Mapping Configuration may contain multiple entries for F1-C traffic. It is up to the IAB node's implementation to decide which entry is selected.

BAP Routing ID Selection at IAB-Donor DU

For a BAP SDU received from upper layer at the donor DU, the BAP entity performs mapping to a BAP address and a BAP Path identity based on:
Downlink Traffic to Routing ID Mapping Configuration, which is derived from IP-to-layer-2 traffic mapping Information List IE configured on the donor DU in TS 38.473.

Each entry of the Downlink Traffic to Routing ID Mapping Configuration contains:
a destination IP address, which is indicated by Destination IAB TNL Address IE in IP header information IE, including an IPv4 address or IPv6 address or an IPv6 address prefix,
an IPv6 flow label, if configured, which is indicated by IPv6 Flow Label IE in IP header information IE,
a DSCP, if configured, which is indicated by DSCP IE in DS Information List IE in IP header information IE, and
a BAP routing ID, which is indicated by BAP Routing ID IE in BH Information IE in TS 38.473.

At the donor DU, for a BAP SDU received from upper layers and to be transmitted in downstream direction, the BAP entity shall:
for the BAP SDU encapsulating an IPv6 packet:
   select an entry from the Downlink Traffic to Routing ID Mapping Configuration which fulfils the following conditions:
      the Destination IP address of this BAP SDU matches the destination IP address in this entry; and
      the IPv6 Flow Label of this BAP SDU matches IPv6 flow label in this entry if configured; and
      the DSCP of this BAP SDU matches DSCP in this entry if configured;
for the BAP SDU encapsulating an IPv4 packet:
   select an entry from the Downlink Traffic to Routing ID Mapping Configuration which fulfils the following conditions:
      the Destination IP address of this BAP SDU matches the destination IP address in this entry; and
      the DSCP of this BAP SDU matches DSCP in this entry if configured;
select the BAP address and the BAP path identity from the BAP routing ID in the entry selected above;

Routing

The BAP entity performs routing based on:
the BH Routing Configuration derived from an F1AP message as specified in TS 38.473.

Each entry of the BH Routing Configuration contains:
a BAP Routing ID consisting of a BAP address and a BAP path identity, which is indicated by BAP Routing ID IE, and
a Next Hop BAP Address which is indicated by Next-Hop BAP Address IE.

For a BAP Data PDU to be transmitted, BAP entity shall:
if the BAP Data PDU corresponds to a BAP SDU received from the upper layer, and
if the BH Routing Configuration has not been (re)configured by F1AP after the last (re)configuration of defaultUL-BH-RLC-channel by RRC:
   select the egress link on which the egress BH RLC channel corresponding to defaultUL-BH-RLC-channel is configured as specified in TS 38.331 for non-F1-U packets;
else if there is an entry in the BH Routing Configuration whose BAP address matches the DESTINATION field, whose BAP path identity is the same as the PATH field, and whose egress link corresponding to the Next Hop BAP Address is available:
   select the egress link corresponding to the Next Hop BAP Address of the entry;

An egress link is not considered to be available if the link is in BH RLF.

For each combination of a BAP address and a BAP path identity, there should be at most one entry in the BH Routing Configuration. There could be multiple entries of the same BAP address in the BH Routing Configuration.
else if there is at least one entry in the BH Routing Configuration whose BAP address matches the DESTINATION field, and whose egress link corresponding to the Next Hop BAP Address is available:
   select an entry from the BH Routing Configuration whose BAP address is the same as the DESTINATION field, and whose egress link corresponding to the Next Hop BAP Address is available;
   select the egress link corresponding to the Next Hop BAP Address of the entry selected above;

Mapping to BH RLC Channel for BAP Data Packets from Collocated BAP Entity at IAB Node

For a BAP Data Packet received from the collocated BAP entity, the transmitting part of the BAP entity performs mapping to an egress BH RLC channel based on:
BH RLC Channel Mapping Configuration, which is derived from BAP layer BH RLC channel mapping Information List IE, and optionally together with the Configured BAP address IE and the BH RLC Channel to be Setup/Modified List IE, as configured on the IAB node in TS 38.473,

Each entry of the BH RLC Channel Mapping Configuration contains:
an ingress link ID, which is indicated by Prior-Hop BAP AddressIE, or by the Configured BAP address IE in UE-associated F1 AP message for upstream,
an egress link ID, which is indicated by Next-Hop BAP Address IE or by the Configured BAP address IE in UE-associated F1 AP message for downstream,
an ingress BH RLC channel ID, which is indicated by Ingress BH RLC CH ID IE or by the BH RLC CH ID IE in UE-associated F1 AP message for upstream, and,
an egress BH RLC channel ID, which is indicated by Egress BH RLC CH ID IE, or by the BH RLC CH ID IE in UE-associated F1 AP message for downstream.

For a BAP Data PDU received from an ingress BH RLC channel of an ingress link and for which the egress link has been selected:
if there is an entry in the BH RLC Channel Mapping Configuration, whose ingress BH RLC channel ID matches the BAP Data PDU's ingress BH RLC channel, whose ingress link ID matches the BAP Data PDU's ingress link, and whose egress link ID corresponds to the selected egress link;
   select the egress BH RLC channel corresponding to egress BH RLC channel ID of this entry;
else:
   select any egress BH RLC channel on the selected egress link;

Mapping to BH RLC Channel for BAP SDUs from Upper Layers at IAB Node

For a BAP SDU received from upper layers at the IAB-node, the BAP entity performs mapping to an egress BH RLC channel based on:
Uplink Traffic to BH RLC Channel Mapping Configuration, which is derived from F1AP message, configured on the IAB-node in TS 38.473.

Each entry of the Uplink Traffic to BH RLC Channel Mapping Configuration contains:
a traffic type specifier, which is indicated by UL UP TNL Information IE for F1-U packets or Non-UP Traffic Type IE for non-F1-U packets in TS 38.473,
an egress link ID, which is indicated by Next-Hop BAP address IE in BH information IE in TS 38.473, and
an egress BH RLC channel ID, which is indicated by BH RLC CH ID IE in BH information IE in TS 38.473.

For a BAP SDU received from upper layers at the IAB node and to be transmitted in upstream direction, whose egress link has been selected, the BAP entity shall:
if the Uplink Traffic to BH RLC Channel Mapping Configuration has not been (re)configured by F1AP after the last (re)configuration of defaultUL-BH-RLC-channel by RRC:
   select the egress BH RLC channel corresponding to defaultUL-BH-RLC-Channel configured in TS 38.331 for non-F1-U packets;
else:
   for the BAP SDU encapsulating an F1-U packet:
      if there is an entry in the Uplink Traffic to BH RLC Channel Mapping Configuration with its traffic type specifier corresponds to the destination IP address and TEID of this BAP SDU and its egress link ID corresponding to the selected egress link;
         select the egress BH RLC channel corresponding to the egress BH RLC channel ID of this entry;
      else:
         select any egress BH RLC channel on the selected egress link;
   for the BAP SDU encapsulating non-F1-U packet:
      if there is an entry from the Uplink Traffic to BH RLC Channel Mapping Configuration with its traffic type specifier corresponds to the traffic type of this BAP SDU and its egress link ID corresponding to the selected egress link;
         select the egress BH RLC channel corresponding to the egress BH RLC channel ID of this entry;
      else:
         select any egress BH RLC channel on the selected egress link;

Note: Uplink Traffic to BH RLC Channel Mapping Configuration may contain multiple entries for F1-C traffic. It is up to IAB node's implementation to decide which entry is selected, but the selected entry has to match the BAP routing ID, i.e. BAP routing ID and BH RLC channel must be derived from the same BH Information IE.

Mapping to BH RLC Channel at Donor DU

For a BAP SDU received from upper layers at the donor DU, the BAP entity performs mapping to an egress BH RLC channel based on:
Downlink Traffic to BH RLC Channel Mapping Configuration, which is derived from IP-to-layer-2 traffic mapping Information List IE, and optionally together with the Configured BAP address IE and the BH RLC Channel to be Setup/Modified List IE, as configured on the donor DU in TS 38.473.

Each entry of the Downlink Traffic to BH RLC Channel Mapping Configuration contains:
a destination IP address, which is indicated by Destination IAB TNL Address IE in IP header information IE including an IPv4 address or IPv6 address or an IPv6 address prefix,
an IPv6 flow label, if configured, which is indicated by IPv6 Flow Label IE in IP header information IE,
a DSCP, if configured, which is indicated by DSCP IE in DS Information List IE in IP header information IE,
an egress link ID, which is indicated by Next-Hop BAP Address IE in BH Information IE, or by the Configured BAP address IE in UE-associated F1AP message, and
an egress BH RLC channel ID, which is indicated by Egress BH RLC CH ID IE in BH Information IE, or by the BH RLC CH ID IE in UE-associated F1AP message.

At the donor DU, for a BAP SDU received from upper layers and to be transmitted in downstream direction, whose egress link has been selected as specified in above with reference to “Routing”, the BAP entity shall:
for the BAP SDU encapsulating an IPv6 packet:
   if there is an entry in the Downlink Traffic to BH RLC Channel Mapping Configuration with its egress link ID corresponding to the selected egress link, and the entry fulfils the following conditions:
      the Destination IP address of this BAP SDU matches the destination IP address in this entry; and
      the IPv6 Flow Label of this BAP SDU matches IPv6 flow label in this entry if configured; and
      the DSCP of this BAP SDU matches DSCP in this entry if configured:
         select the egress BH RLC channel corresponding to egress BH RLC channel ID of this entry;
   else:
      select any egress BH RLC channel on the selected egress link;
for the BAP SDU encapsulating an IPv4 packet:
   if there is an entry in the Downlink Traffic to BH RLC Channel Mapping Configuration with its egress link ID corresponding to the selected egress link, and the entry fulfils the following conditions:
      the Destination IP address of this BAP SDU matches the destination IP address in this entry; and
      the DSCP of this BAP SDU matches DSCP in this entry if configured:
         select the egress BH RLC channel corresponding to egress BH RLC channel ID of this entry;
      else:
         select any egress BH RLC channel on the selected egress link;

Receiving Operation Upon receiving a BAP Data PDU from lower layer (i.e. ingress BH RLC channel), the receiving part of the BAP entity shall:
if DESTINATION field of this BAP PDU matches the BAP address of this node:
   remove the BAP header of this BAP PDU and deliver the BAP SDU to upper layers;
else:
   deliver the BAP Data Packet to the transmitting part of the collocated BAP entity.

RRC Message Design for IP address Allocation

The RRC signaling for IAB IP address allocation is designed based on the following input from RAN3:
For IAB-donor-based IP address allocation:
   An IAB-node can request from the donor CU via UL RRC message:
      One 64-bit IPv6 address prefix or up to 8 full IPv6 addresses per specific usage, and/or
      Up to 8 full IPv4 addresses per specific usage.
   Specific IP address/prefix usages are: F1-C traffic, F1-U traffic and non-F1 traffic.
   The donor CU indicates to the IAB node via downlink (DL) RRC message the full IPv6 addresses or IPv6 address prefixes and/or IPv4 addresses and the specific usage of each allocated full address and/or prefix.
For operations, administration, and management (OAM)-based IP address allocation:
   For OAM-based IP address allocation, the IAB node indicates to the donor CU via UL RRC message:
      One 64-bit IPv6 address prefix or up to 8 full IPv6 addresses, and/or
      Up to 8 full IPv4 addresses.
   For each IP address/prefix allocated by the operations, administration, and management (OAM), the IAB node also indicates the specific usage.
   The same maximum number of allocated addresses/prefixes as for the IAB-donor-based IP address allocation applies.
   Specific IP address/prefix usages are: F1-C traffic, F1-U traffic and non-F1 traffic.
   The purpose of indicating the OAM-allocated IP addresses to the donor CU is to enable the donor CU to configure the donor DU with the mapping between the IP addresses/prefix allocated to the IAB-node and the corresponding DL BAP Routing IDs.
The IAB-node should be able to send the abovementioned UL RRC messages at any time after network integration.
   The IAB-MT may need to first obtain OAM configuration (including the IP addresses and/or prefixes) via PDU session or PDN connection.
   For EN-DC, OAM connectivity may be obtained via Long-Term Evolution (LTE) or via NR.

IP addresses are updated via DL RRC signaling, where the updated address replaces the old one.

### SUMMARY

There currently exist certain challenge(s). 3GPP Rel-16 specifications for the IAB network support the rerouting of traffic performed by the intermediate IAB nodes under certain conditions such as RLF. As explained above with reference to “Routing”, for rerouting the traffic, the intermediate IAB nodes will use the destination BAP address carried in the packets headers to find an appropriate alternative egress BH link for forwarding the packets when the actual/intended egress BH link is no longer available (due to RLF).

FIG. 4 shows an example of an IAB network. The IAB network illustrated in FIG. 4 includes a donor CU, a first donor DU DU1, a second donor DU DU2, a first IAB node IAB1, a second IAB node IAB2, a third IAB node IAB3, a fourth IAB node IAB4, and a fifth IAB node IAB5. There are two available uplink paths from the fourth IAB node IAB4 to the donor CU. The first path (“Path1”) corresponds to a path traversing IAB4, IAB1, and DU1. The second path (“Path2”) corresponds to a path traversing IAB 4, IAB 3, IAB1, and DU1. The third path (“Path3”) corresponds to a path traversing IAB4, IAB3, IAB2, and DU2. There are two available uplink paths from the fifth IAB node IAB 5 to the donor CU. In this example, if the fourth IAB node IAB4 lost connectivity with the first IAB node IAB1, then the fourth IAB node IAB4 can reroute packets with BAP Path ID (of the BAP header) set to Path1 via the egress BH link towards the third IAB node IAB3. Upon receiving the rerouted packets on its BH ingress link, the third IAB node IAB3 will examine the BAP routing ID carried in the packet headers. Since no egress BH link is configured in the routing table of the third IAB node IAB3 for the BAP routing ID (i.e., BAP address DU1 and Path1) carried in the rerouted packets, the third IAB node IAB3 will make routing decision based on the destination BAP address only and will deliver the rerouted packets to the first IAB node IAB1. In this example, rerouting of packets is possible because the original path (i.e., the first uplink path from IAB4 to CU) and the alternative path for rerouted traffic (i.e., the second uplink path from IAB4 to CU) both terminate at the first donor DU DU1, hence the intermediate IAB nodes can use only the BAP address rather than the BAP routing ID (i.e., BAP address and BAP Path ID) to forward the packets.

However, suppose the fourth IAB node IAB4 lost connectivity with the third IAB node IAB3, and the fourth IAB node IAB4 receives packets with BAP address field and BAP Path ID fields set to DU2 and Path3. In this case, the fourth IAB node IAB4 will drop the packets as now the BAP routing ID carried in the packets headers cannot be matched with any egress BH link in the BH routing configuration, given that the only path ID configured for the BAP address DU2 in the BH routing configuration is Path3, but the link between IAB4 and IAB3 is broken.

Even if the fourth IAB node IAB4 and the first IAB node IAB1 just forward these packets (with destination BAP address set to DU2) on their egress BH link without considering the BAP address carried in these packet headers (assuming that this is destined for the same donor CU), the first donor DU DU1 will have no option but discard these packets. This is because traffic mapping (i.e., routing and BH RLC channels) tables at the first donor DU DU1 are configured based on the IPv6 Flow labels, Differentiated Services Code Point (DSCP) values, BAP routing IDs of the traffic deliver via the first donor DU DU1, and will not forward any traffic to donor CU that is not configured in the mapping tables to avoid any denial of service attack. In other words, the donor DU will discard the rerouted traffic as the source IP address of the rerouted packets would not be compliant with the address pool of the local subnet as assigned by the donor DU.

Certain aspects of the present disclosure and their embodiments may provide solutions to these or other challenges. The present disclosure proposes a solution for extending the rerouting of traffic from intra-Donor DU to inter-Donor DU in order to make the IAB network more robust against RLF and to enhance the network load balancing capabilities. In some examples of the present disclosure and their embodiments, the inter-donor DU rerouting may also involve inter-CU routing, wherein the rerouting occurs at an intermediate IAB node from one donor DU controller by a CU to another donor DU controlled by another CU.

There are, proposed herein, various embodiments which address one or more of the issues disclosed herein. Certain embodiments may facilitate intra-DU rerouting of traffic under RLF and minimize packet losses. Certain embodiments may enhance the network load balancing capabilities by allowing intermediate IAB nodes to utilize a larger set of paths (i.e., paths terminating at all donor DUs under a donor CU).

### BRIEF DESCRIPTION OF THE DRAWINGS

FIG. 1 is a reference diagram for an IAB architecture;

FIG. 2 illustrates a baseline user plane protocol stack for IAB;

FIGS. 3A, 3B, and 3C illustrate a baseline control plane protocol stack for IAB;

FIG. 4 shows an example of an IAB network;

FIG. 5 depicts a method performed by a first donor DU in an IAB network in accordance with particular embodiments;

FIG. 6 depicts a method performed by a donor CU in an IAB network in accordance with particular embodiments;

FIG. 7 depicts a method performed by a donor DU in an IAB network in accordance with particular embodiments;

FIG. 8 is a schematic diagram illustrating a wireless network according to some embodiments;

FIG. 9 is a schematic diagram illustrating a user equipment according to some embodiments;

FIG. 10 is a schematic block diagram illustrating a virtualization environment according to some embodiments;

FIG. 11 shows a telecommunication network connected via an intermediate network to a host computer in accordance with some embodiments;

FIG. 12 shows a host computer communicating via a base station with a user equipment over a partially wireless connection in accordance with some embodiments;

FIG. 13 is a flowchart illustrating a method implemented in a communication system, in accordance with one embodiment;

FIG. 14 is a flowchart illustrating a method implemented in a communication system, in accordance with one embodiment;

FIG. 15 is a flowchart illustrating a method implemented in a communication system, in accordance with one embodiment;

FIG. 16 is a flowchart illustrating a method implemented in a communication system, in accordance with one embodiment;

FIG. 17 illustrates a schematic block diagram of an apparatus in a wireless network;

FIG. 18 illustrates a schematic block diagram of an apparatus in a wireless network; and

FIG. 19 illustrates a schematic block diagram of an apparatus in a wireless network.

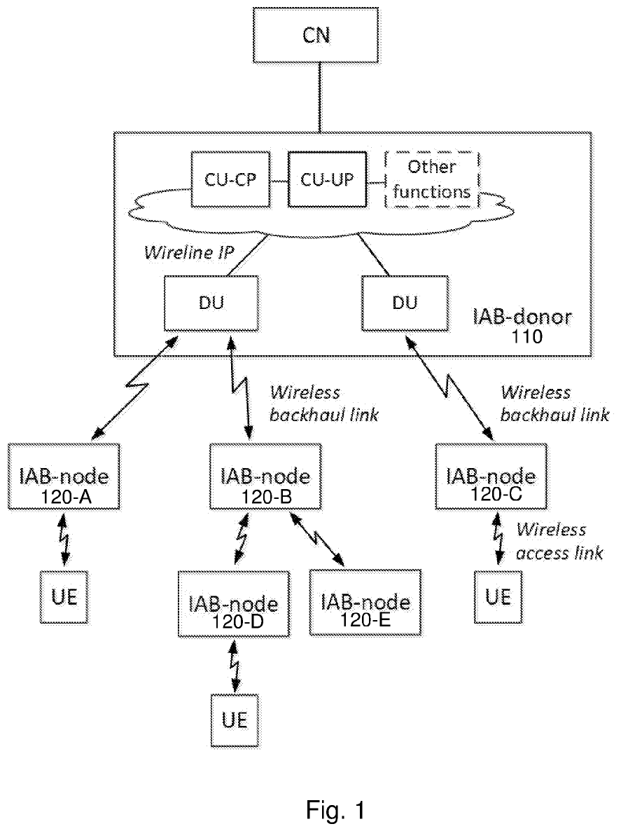

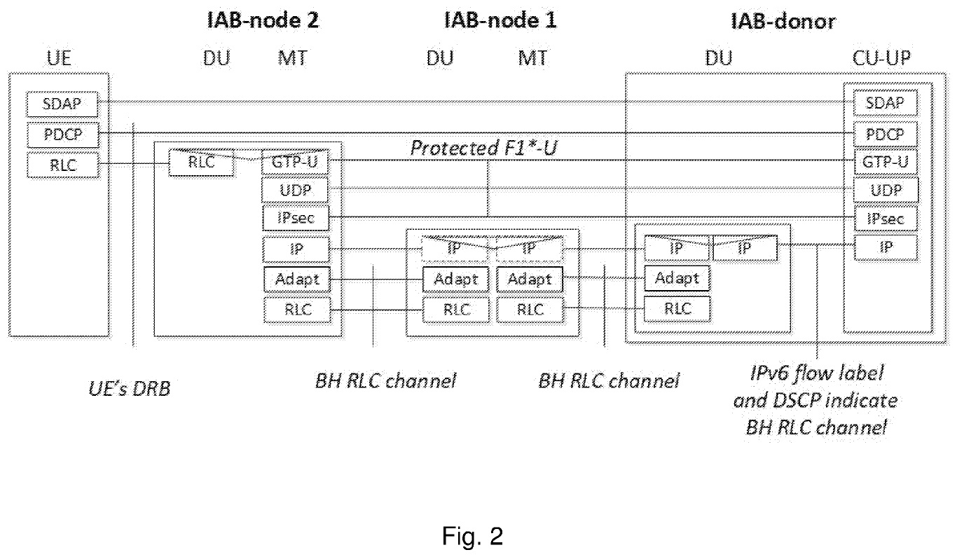

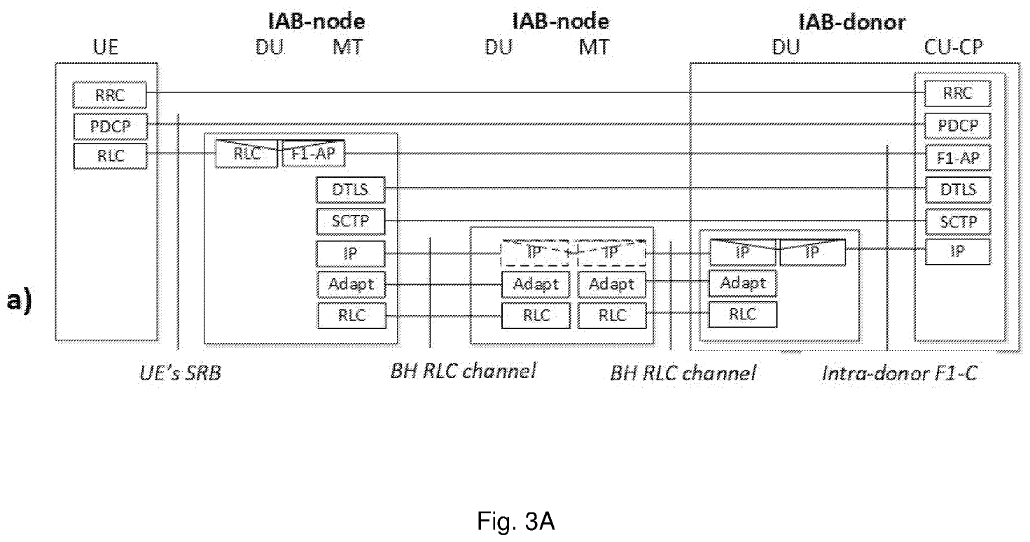

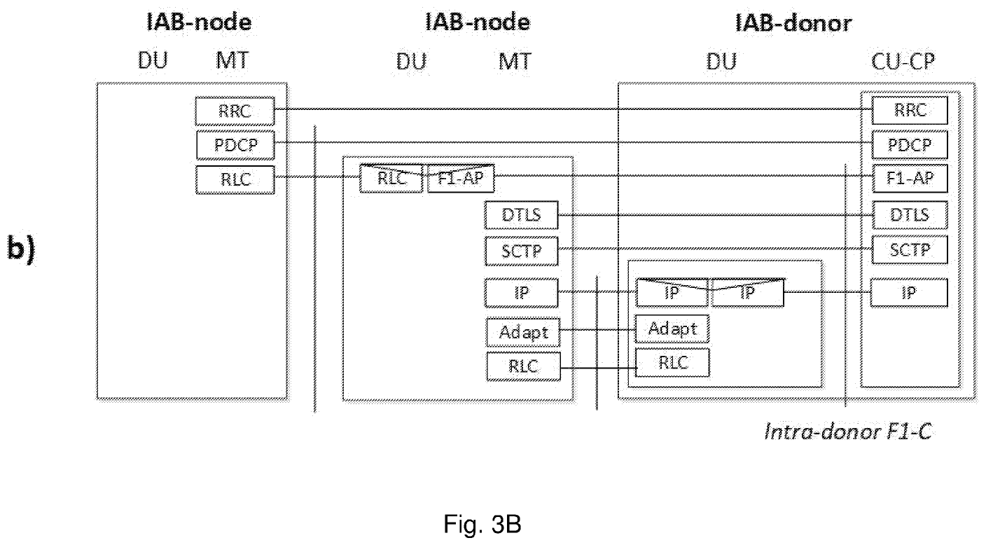

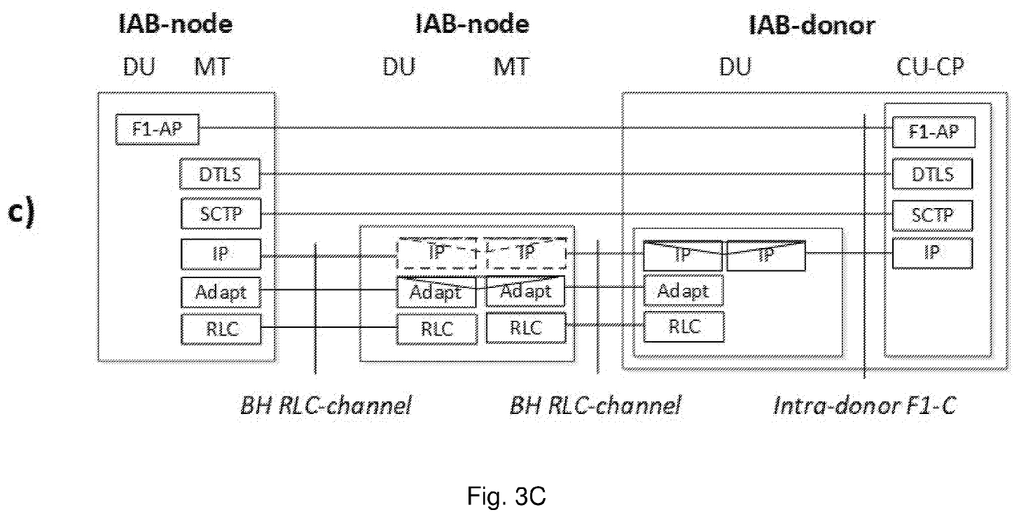

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In the explanation herein, the terms “IAB donor CU”, “donor-CU”, “donor CU”, and “CU” are used interchangeably, the terms “IAB donor DU”, “donor-DU”, “donor DU”, and “DU” are used interchangeably, the terms “BAP destination address” and “BAP address” are used interchangeably, and the term “intermediate IAB node” is used to refer to an IAB node which receives data from an ingress BH RLC channel from another IAB node or donor DU, and which transmits data on an egress channel to another IAB node or to the donor DU.

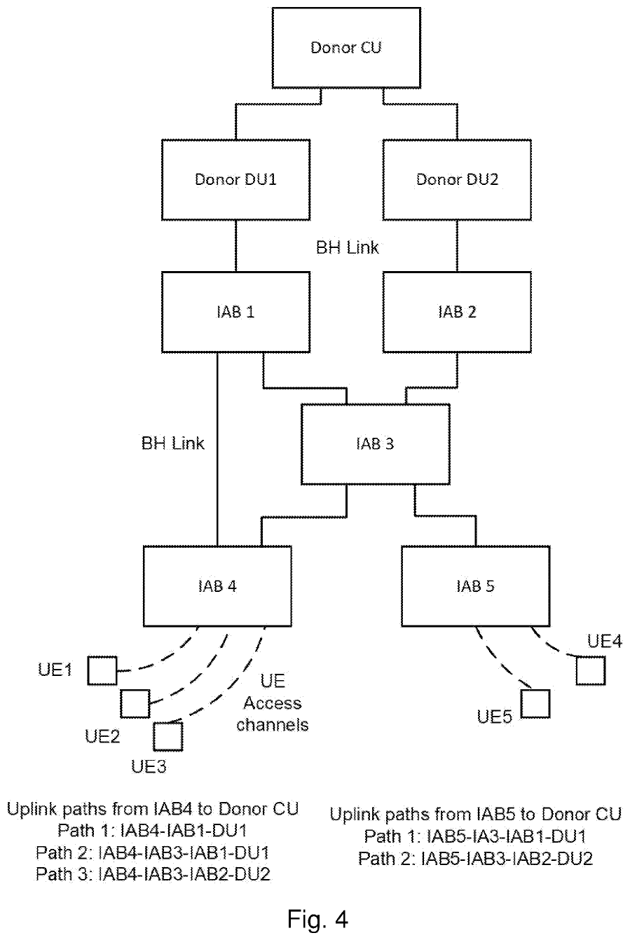

To illustrate the embodiments contemplated herein, the example scenario as shown in FIG. 4 is used. In the following explanation, it is assumed that the first donor DU DU1 and the second donor DU DU2 of FIG. 4 may be controlled by the same CU or different CUs. For routing from the fourth IAB node IAB4 to the donor CU, there are three paths respectively labelled “Path 1”, “Path 2”, and “Path 3” as listed on the left-hand side of the diagram in FIG. 4. Also, for routing from the fifth IAB node IAB5 to the donor CU, there are two paths respectively labelled “Path 1” and “Path 2” as listed on the right-hand side of the diagram in FIG. 4.

In an embodiment, the donor CU may assign the same BAP destination address to all donor DUs under its domain, and may allocate different or unique BAP routing IDs to each path (originating from access IAB node(s)) terminating at these donor DUs. For example, referring to the scenario shown in FIG. 4, for routing from the fourth IAB node IAB4 to the first donor DU DU1 and from the fourth IAB node IAB4 to the second donor DU DU2, the BAP routing ID may be D1, D2, and D3 for Path1, Path2, and Path3 (as listed on the left-hand side of the diagram) respectively. “D” in this context denotes the BAP destination address, while “1”, “2”, “3” each indicates the BAP Path ID. Similarly, for routing from the fifth IAB node IAB5 to the first donor DU DU1 and from the fifth IAB node IAB5 to the second IAB node DU2, the BAP routing ID may be D4 and D5 for Path1 and Path2 (as listed on the right-hand side of the diagram) respectively. By assigning the same BAP address to all the donor DUs under a donor CU, the intermediate IAB nodes can reroute packets (instead of dropping them) on links or paths that terminate at a different donor DUs.

In an embodiment (which can be combined with the embodiment described above), to address the issue of unwanted discarding of rerouted packets at the donor DUs (due to the source IP addresses of the rerouted packets not being compliant with an address pool of a local subnet assigned by a donor DU), the donor CU may share the IP address(es) allocated to IAB nodes by a donor DU (or by an Operations, Administration and Maintenance (OAM) module, but mapped to BAP routing IDs assigned to a donor DU) with all the other donor DUs.

For example, referring to FIG. 4, the second donor DU DU2 may receive information about the IP addresses assigned to IAB nodes under the first donor DU DU1, and vice versa. The donor CU may provide this information via F1 signaling between donor CU and donor DU, or the donor DU may receive this information via OAM. Thus, whenever a donor DU receives rerouted packets, the donor DU may first determine whether the source IP addresses of the packets match IP addresses in the list or table of IP addresses under its domain; if there is no match, then the donor DU may examine the list or table of IP addresses under other donor DUs' domains. In case of a match, the donor DU may forward the packets to upper layer(s). Otherwise, the donor DU may drop the packets. The rules for an intermediate IAB node for selecting one path or another will be explained in more detail below.

In some embodiments, the donor CU may configure one or more dedicated BH RLC channels on the links (i.e., the link between the first IAB node IAB1 and the first donor DU DU1 and the link between the second IAB node IAB2 and the second donor DU DU2 in FIG. 4) terminating at donor DUs. The one or more dedicated BH RLC channels may only be used for forwarding rerouted traffic towards donor DUs. Thus, the immediate children nodes (i.e., the first IAB node IAB1 and the second IAB node IAB2 FIG. 4) of the donor DUs may only use the dedicated BH RLC channels for forwarding rerouted traffic. When a donor DU receives packets on such ingress BH RLC channel(s), the DU can determine that these received packets are rerouted packets carrying IP source address(es) assigned (or under domain) by other donor DUs under the control of the same donor CU. Hence, the donor DU can forward the packets to an upper layer instead of discarding the packets. This technique of configuring dedicated BH RLC channels can also be extended to other children nodes (e.g., the third IAB node IAB3 in FIG. 4) that are not immediately connected to donor DUs.

For example, referring to FIG. 4, the third IAB node IAB3 may select a dedicated egress BH RLC channel configured by the donor CU when the third IAB node IAB3 receives a packet whose BAP header indicates a BAP destination which is not present in the BH routing configuration list, and/or when the Path ID indicated in the BAP header of the packet is not present in the BH routing configuration, or when the tuple (i.e., the BAP destination and the Path ID) indicated in the BAP header is present in the BH routing configuration, but the link towards the next hop (child or parent IAB node) for such BAP destination and/or path ID is unavailable, for example due to backhaul RLF on the link, or the link is congested, or the radio measurements for the link are bad (e.g., below/above certain predetermined threshold(s)).

In some embodiments, an intermediate IAB node (whether it is directly connected to Donor DU or not) may use one of the reserve bits in the BAP header of a packet whenever the node reroutes the packet. For example, when an IAB node (e.g., the third IAB node IAB3 in FIG. 4) receives a packet with BAP path ID not configured in its BH routing configuration, or if the BAP destination indicated in the BAP header is not present in the BH routing configuration list, or if the tuple (i.e., the path ID and the BAP destination) indicated in the BAP header is present in the BH routing configuration but the link towards the next hop (child or parent IAB node) for such BAP destination and/or path ID is unavailable, for example due to backhaul RLF on the link, or the link is congested, or the radio measurements for this link are bad (e.g., below/above certain predetermined threshold(s)), the intermediate IAB node which performs the rerouting (e.g., the third IAB node IAB3) may set the reroute bit flag to 1, and may forward the packet on an appropriate egress link. When the next intermediate IAB node (e.g., the first IAB node IAB1) receives such packet (with rerouted bit flag set to 1), it may forward it on an appropriate egress link using the criteria outlined below with reference to the rules for path selection. Finally, when the packet reaches the donor DU (e.g., the first donor DU DU1 in FIG. 4), the DU can determine (via the bit flag in the BAP header) that the packet has been rerouted. The donor DU may remove the BAP header and may forward the rerouted packet to an upper layer, despite the fact that the source IP address (carried by the packet) is not assigned by the donor DU or mapped to the BAP routing IDs assigned to the donor DU.

In some embodiments, an intermediate IAB node may select a special path ID in the event such IAB intermediate node receives a packet with BAP path ID that is not configured in its BH routing configuration, or if the BAP destination indicated in the BAP header is not present in the BH routing configuration list, or if the tuple (i.e., the path ID and the BAP destination) indicated in the BAP header is present in the BH routing configuration but the link towards the next hop (child or parent IAB node) for such BAP destination and/or path ID is unavailable, for example due to backhaul RLF on the link, or the link is congested, or the radio measurements for this link are bad (e.g., below/above certain predetermined threshold(s)). Such special path ID may be preconfigured by the donor CU. When the donor DU receives such packet containing the special path ID, it may pass the packet to an upper layer. Similarly, any other intermediate node receiving the packet with the special path ID set may route the packet according to the BAP destination included in the BAP header and the BH routing configuration associated to the said BAP destination.

Furthermore, in these embodiments, in the event an IAB intermediate node receives a packet with BAP destination indicated in the BAP header that is not present in the BH routing configuration list, the IAB node may modify the BAP header in the manner as described above (e.g., setting a reroute bit flag), and/or may remove from the BAP header the said indicate BAP destination that cannot be match with any other BAP destination included in the BH routing configuration. The new BAP destination included in the BAP header may be any BAP destination among the ones included in the BH routing configuration.

In order to enable IAB intermediate nodes to perform rerouting of incoming packets, different rules can be configured at the IAB intermediate nodes by the donor CU, the donor CU being in charge of configuring these intermediate IAB nodes. It is noted that the procedures disclosed in this section can be applicable to the upstream or downstream traffic.

The rerouting action can occur when an IAB intermediate node receives a packet and any of the following conditions applies:
1. The packet carries in the BAP header a BAP path ID which is not configured in the BH routing configuration configured at the IAB intermediate node,
2. The packet carries in the BAP header a BAP destination which is not present in the BH routing configuration list,
3. The packet carries in the BAP header a tuple (i.e., path ID and BAP destination) which is present in the BH routing configuration but the link towards the next hop (child or parent IAB node) for such BAP destination and/or path ID is unavailable, e.g. RLF, or the link is congested, or the radio measurements for this link are bad (e.g., below/above certain predetermined threshold(s)).
   With respect to link congestion, the donor CU may configure the intermediate node with certain rule(s) for evaluating the congestion of the egress link. For example, in the event the intermediate node receives flow control feedback from the parent/child node indicating that a buffer size at the parent/child node is above a certain threshold for a certain amount of time, the IAB intermediate node may perform local routing. Alternatively, for the case of the upstream, in the event the uplink transmissions are experiencing a long delay, as indicative by the time elapsed between reception of Medium Access Control (MAC) SDU from higher layers until transmission to the parent node of such MAC SDU, the IAB node may perform rerouting when the delay exceeds a delay threshold. This delay threshold may be configured by the donor CU.
   With respect to radio measurements, the donor CU may configure the intermediate node with certain rule(s) for evaluating the radio conditions of the egress link. For example, the donor CU can provide a threshold with respect to at least one of: Reference Signal Received Power (RSRP), Reference Signal Received Quality (RSRQ), Received Signal Strength Indicator (RSSI), and Block Error Ratio or Block Error Rate (BLER) level below which the IAB node is allowed to perform rerouting.

When any of the above conditions applies, the IAB intermediate node may perform rerouting of the concerned packet according to any of the following rules:
1. The intermediate IAB node may select, for such packet, another path among the paths represented by the path IDs present in the BH routing configuration and one that is associated to the BAP destination indicated in the BAP header. If there is more than one path represented by path IDs associated with the said BAP destination in the BH routing configuration, the IAB node may select the path corresponding to an egress link between the IAB node and the IAB node at the next hop. The best egress link may be selected on the basis of the radio conditions, and/or on the basis of load conditions. For example, the best egress link might be a link with the smallest number of BH RLC channels configured, and/or one with the fewest number of UE DRBs configured in the configured BH RLC channel for such egress link. Alternatively, the egress link may be configured and predetermined by the network. In this case, the donor CU may configure the IAB node with specific mapping rule(s) to map rerouted packets to a predefined egress channel.
2. If there is no path associated to the BAP destination indicated in the BAP header available in the BH routing configuration, the intermediate IAB node may perform one of:
   Discard the concerned packet.
   Select another path represented by a path ID among the list of available path ID configured in the BH routing configuration. The path selection may be based on the evaluation of the egress link associated to the selected path, based on radio conditions and/or load conditions as described in the above rule (rule 1).
      With regard to the path ID in the BAP header, after selecting an alternative path as described above, the concerned IAB intermediate node may modify the BAP header of the concerned packet such that the path ID is modified to correspond to one of the path IDs associated to the selected egress link. Alternatively, the modified path ID may correspond to a special path ID as explained in embodiments described above. As yet another alternative, the path ID may be left unchanged except for some of the reserved bits in the BAP header which can be modified (as explained in embodiments described above) in order to signal to the IAB node at the next hop that a local rerouting occurred at the concerned intermediate IAB node.
      With regard to the BAP destination in the BAP header, after selecting the alternative path, the concerned IAB intermediate node may leave the BAP destination unchanged. This alternative may be beneficial in the event for example, the IAB node at the next hop has such BAP destination configured in the BH routing configuration. Such IAB node at the next hop may then recognize the BAP destination but not the path ID. In this case, the IAB node at the next hop may perform the step as described in the above rule (rule 1).
      As another alternative, the concerned IAB node may modify the BAP destination by replacing it with the BAP destination another donor DU. This alternative may be beneficial in that the intended destination to which the IAB nodes at the next hops deliver this packet is ensured. Some of the field in the BAP header may be changed in order to signal to the IAB nodes at the next hops and to the donor DU that there has been a change in the BAP destination, so that the donor DU upon receiving such packet may pass the packet to the donor CU rather than discarding it. In another example, the IAB intermediate node may signal in the BAP header the original BAP destination that has been changed. In this way, the IAB nodes at the next hops or the intermediate IAB nodes may perform rerouting according to the above rule (rule 1), if the original BAP destination is available in the BH routing configuration.

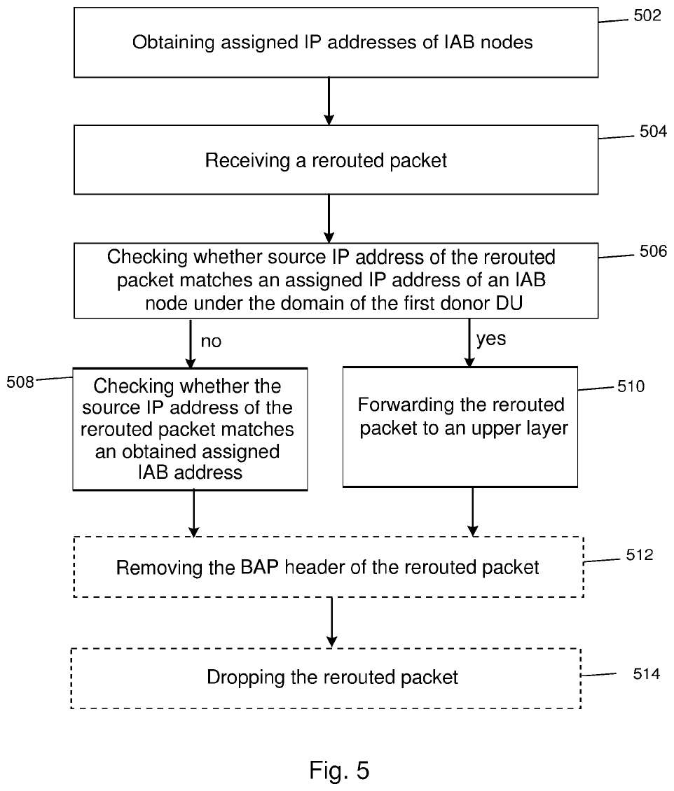

FIG. 5 depicts a method performed by a first donor DU in an IAB network in accordance with particular embodiments. The IAB network comprises a donor CU, a plurality of donor DUs including the first donor DU, and a plurality of IAB nodes. Each of the plurality of IAB nodes is assigned an IP address and is under the domain of one or more of the plurality of donor DUs.

The method begins at step 502 at which for each of the plurality of IAB nodes under the domain of each donor DU in the plurality of donor DUs, a respective assigned IP address of the respective IAB node is obtained. In some embodiments, a respective assigned IP address of the respective IAB node may be obtained from the donor CU.

Then, the method proceeds to step 504 at which a rerouted packet is received.

Then, the method proceeds to step 506 at which whether a source IP address of the rerouted packet matches an assigned IP address of an IAB node under the domain of the first donor DU is checked.

If it is determined at step 506 that the source IP address of the rerouted packet does not match an assigned IP address of an IAB node under the domain of the first donor DU, the method proceeds to step 508 whether the source IP address of the rerouted packet matches an assigned IP address obtained by the donor DU is checked.

If it is determined at step 506 that the source IP address of the rerouted packet matches an assigned IP address obtained the donor DU, the method proceeds to step 510 at which the rerouted packet is forwarded to an upper layer.

In some embodiments, the method may further comprise step 512 at which the BAP header of the rerouted packet is removed.

In some embodiments, the method may further comprise step 514 at which the rerouted packet is dropped if the source IP address of the rerouted packet does not match any obtained IP addresses.

Embodiments herein also include corresponding apparatuses. Embodiments herein for instance include a donor DU configured to perform any of the steps of any of the embodiments described above with reference to FIG. 5 for the donor DU.

Embodiments also include a donor DU comprising processing circuitry and power supply circuitry. The processing circuitry is configured to perform any of the steps of any of the embodiments described above for the donor DU. The power supply circuitry is configured to supply power to the donor DU.

Embodiments further include a donor DU comprising processing circuitry. The processing circuitry is configured to perform any of the steps of any of the embodiments described above for the donor DU. In some embodiments, the donor DU further comprises communication circuitry.

Embodiments further include a donor DU comprising processing circuitry and memory. The memory contains instructions executable by the processing circuitry whereby the donor DU is configured to perform any of the steps of any of the embodiments described above for the donor DU.

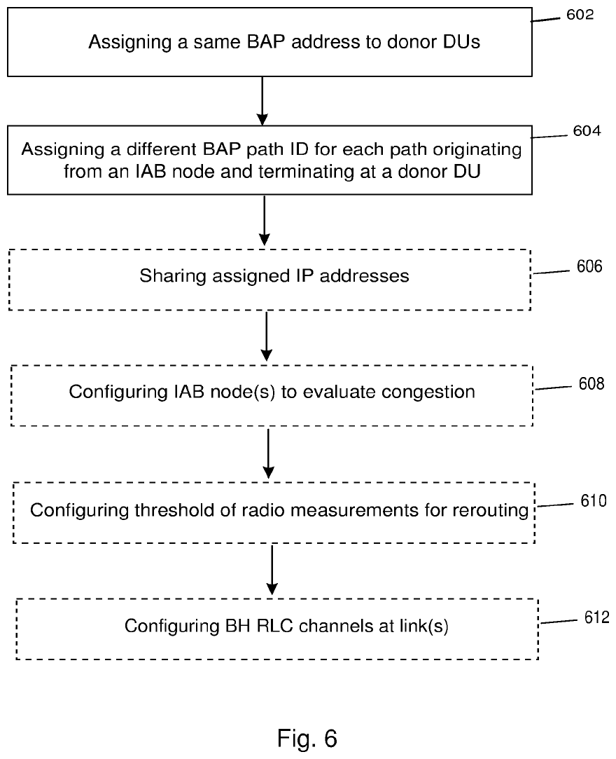

FIG. 6 depicts a method performed by a donor CU in an IAB network in accordance with particular embodiments. The IAB network comprises the donor CU, a plurality of donor DUs, and a plurality of IAB nodes.

The method beings at step 602 at which a same Backhaul Adaptation Protocol (BAP) address is assigned to each of the plurality of donor DUs.

Then, the method proceeds to step 604 at which a different BAP path ID is assigned for each path originating from an IAB node and terminating at one of the plurality of donor DUs. In some embodiments, each different BAP path ID may be a unique BAP path ID.

In some embodiments, the method may further comprise step 606 at which for each of the plurality of IAB nodes under the domain of a donor DU, a respective assigned IP address of the respective IAB node is shared.

In some embodiments, the method may further comprise step 608 at which at least one of the plurality of IAB nodes is configured to evaluate a level of congestion of an egress link of the respective IAB node, and step 610 at which a threshold of radio measurements below which a respective IAB node is allowed to perform rerouting is configured for at least one of the plurality of IAB nodes.

In some embodiments, configuring an IAB node to evaluate a level of congestion of an egress link of the IAB node at step 608 may comprises performing at least one of:
configuring the IAB node to receive flow control feedback from at least one of a parent node and a child node of the IAB node, the flow control feedback including a buffer size at the respective at least one of a parent node and a child node, and
configuring the IAB node to determining whether the buffer size at the at least one of a parent node and a child node is over a predetermined threshold; and configuring the IAB node to determine whether an elapsed time between reception of a data unit at the IAB node and transmission of the data unit to a parent node is over a predetermined threshold.

In some embodiments, the method may further comprise step 612 at which one or more dedicated BH RLC channels are configured at one or more links, each of the one or more links being between an IAB node and a donor DU or between two IAB nodes, and each of the one or more dedicated BH RLC channels being only used for forwarding rerouted traffic.

Embodiments herein also include corresponding apparatuses. Embodiments herein for instance include a donor CU configured to perform any of the steps of any of the embodiments described above with reference to FIG. 6 for the donor CU.

Embodiments also include a donor CU comprising processing circuitry and power supply circuitry. The processing circuitry is configured to perform any of the steps of any of the embodiments described above for the donor CU. The power supply circuitry is configured to supply power to the donor CU.

Embodiments further include a donor CU comprising processing circuitry. The processing circuitry is configured to perform any of the steps of any of the embodiments described above for the donor CU. In some embodiments, the donor CU further comprises communication circuitry.

Embodiments further include a donor CU comprising processing circuitry and memory. The memory contains instructions executable by the processing circuitry whereby the donor CU is configured to perform any of the steps of any of the embodiments described above for the donor CU.

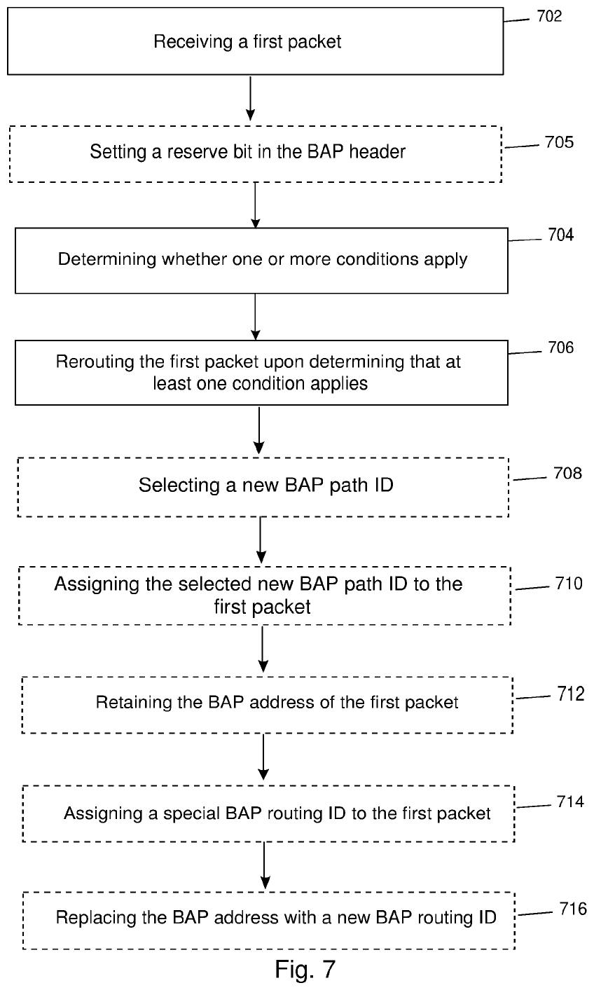

FIG. 7 depicts a method performed by an IAB node in an IAB network in accordance with particular embodiments. The IAB network comprises a donor CU, a plurality of donor DUs, and a plurality of IAB nodes including the IAB node.

The method begins at step 702 at which a first packet is received. The first packet has a BAP routing ID in its header, and the BAP routing ID comprises a BAP path ID and a BAP address. Furthermore, the IAB node has its BH routing configuration.

Then, the method proceeds to step 704 at which whether at least one of the following conditions apply to the received first packet is determined:
the BAP path ID of the first packet is not present in the BH routing configuration of the IAB node;
the destination indicated by the BAP address of the received packet is not present in the BH routing configuration of the IAB node; and
   a link towards a next hop for the BAP routing ID of the first packet is unavailable, or the link is congested, or radio measurements for the link are below a predetermined threshold

Then, the method proceeds to step 706 at which the first packet is rerouted upon determining that at least one of the conditions apply.

In some embodiments, prior to rerouting the first packet at step 706, the method may further comprise step 705 at which one of the reserve bits in the BAP header of the first packet is set at a specific value to indicate that the first packet is rerouted. In some embodiments, the reserve bit may be a reroute bit, and setting the reroute bit at step 705 may comprise setting the bit value to 1.

In some embodiments, the method may further comprise step 708 at which a new BAP path ID is selected among one or more BAP path IDs present in the BH routing configuration of the IAB node. The selected new BAP path ID may be associated to the destination indicated by the BAP address of the first packet.

The method may further comprise step 710 at which the selected new BAP path ID is assigned to the first packet. In these embodiments, rerouting the first packet at step 706 may be performed based on the new BAP path ID.

In some embodiments, selecting a new BAP path ID at step 708 may comprise selecting a BAP path ID that corresponds to an egress link between the IAB node at which the first packet is received and an IAB node at a next hop. In some embodiments, selecting the new BAP path ID at step 708 may be based on evaluation of at least one of: radio conditions of egress links associated with the one or more paths present in the BH routing configuration, load conditions of egress links associated with the one or more paths present in the BH routing configuration. In these embodiments.

In some embodiments, the method may further comprise step 712 at which the BAP address of the first packet is retained after assigning the new selected BAP path ID.

In some embodiments, the method may further comprise step 714 at which a special BAP routing ID is assigned to the received first packet upon determining at least one of the conditions apply to the received first packet. In these embodiments, the first packet may be a packet that is to be forwarded by a donor DU to an upper layer. Also, in these embodiments, the special BAP routing ID may be pre-configured by the donor CU.

In some embodiments, the method may further comprise step 716 at which the BAP address of the first packet is replaced with a new BAP routing ID upon determining that the destination indicated by the BAP routing ID of the received first packet is not present in the BH routing configuration of the IAB node. In these embodiments, the new BAP routing ID may indicate a destination that is included in the BH routing configuration of the IAB node.

Embodiments herein also include corresponding apparatuses. Embodiments herein for instance include an IAB node configured to perform any of the steps of any of the embodiments described above with reference to FIG. 7 for the IAB node.

Embodiments also include an IAB node comprising processing circuitry and power supply circuitry. The processing circuitry is configured to perform any of the steps of any of the embodiments described above for the IAB node. The power supply circuitry is configured to supply power to the IAB node.

Embodiments further include an IAB node comprising processing circuitry. The processing circuitry is configured to perform any of the steps of any of the embodiments described above for the IAB node. In some embodiments, the IAB node further comprises communication circuitry.

Embodiments further include an IAB node comprising processing circuitry and memory. The memory contains instructions executable by the processing circuitry whereby the IAB node is configured to perform any of the steps of any of the embodiments described above for the IAB node.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

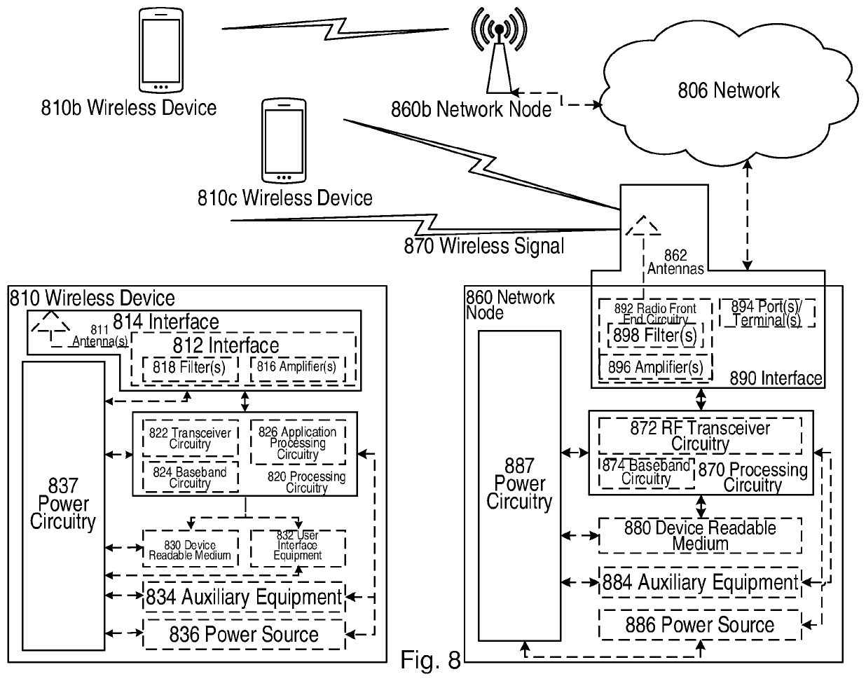

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 806, network nodes 860 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5th Generation (5G) standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centres (MSCs), Mobility Management Entity (MMEs)), Operation and Maintenance (O&M) nodes, Operations Support System (OSS) nodes, Self Optimized Network (SON) nodes, positioning nodes (e.g., Evolved-Serving Mobile Location Centres (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and a RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, Wide Code Division Multiplexing Access (WCDMA), LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SOC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units

In certain embodiments, some or all of the functionality described herein as being provided by a network node, base station, eNB or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data or information, including a computer program, software, an application including one or more of logic, rules, code, tables, etc. and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated.

Interface 890 is used in the wired or wireless communication of signalling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862. Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872, as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 890 and may be any type of antenna capable of transmitting and receiving data and/or signals wirelessly. In some embodiments, antenna 862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data and/or signals may be received from a wireless device, another network node and/or any other network equipment. Similarly, antenna 862, interface 890, and/or processing circuitry 870 may be configured to perform any transmitting operations described herein as being performed by a network node. Any information, data and/or signals may be transmitted to a wireless device, another network node and/or any other network equipment.

Power circuitry 887 may comprise, or be coupled to, power management circuitry and is configured to supply the components of network node 860 with power for performing the functionality described herein. Power circuitry 887 may receive power from power source 886. Power source 886 and/or power circuitry 887 may be configured to provide power to the various components of network node 860 in a form suitable for the respective components (e.g., at a voltage and current level needed for each respective component). Power source 886 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836 and power circuitry 837. WD 810 may include multiple sets of one or more of the illustrated components for different wireless technologies supported by WD 810, such as, for example, GSM, WCDMA, LTE, NR, WiFi, WiMAX, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 820 may be configured to perform any receiving or transmitting operations described herein as being performed by a WD. Any information, data and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprise one or more filters 818 and amplifiers 816. Radio front end circuitry 814 is connected to antenna 811 and processing circuitry 820, and is configured to condition signals communicated between antenna 811 and processing circuitry 820. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 810 components, such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments processing circuitry 820 of WD 810 may comprise a SOC. In some embodiments, RF transceiver circuitry 822, baseband processing circuitry 824, and application processing circuitry 826 may be on separate chips or sets of chips. In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc. and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices and circuits, and output interfaces, devices and circuits. User interface equipment 832 is configured to allow input of information into WD 810, and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices or power cells, may also be used. WD 810 may further comprise power circuitry 837 for delivering power from power source 836 to the various parts of WD 810 which need power from power source 836 to carry out any functionality described or indicated herein. Power circuitry 837 may in certain embodiments comprise power management circuitry. Power circuitry 837 may additionally or alternatively be operable to receive power from an external power source; in which case WD 810 may be connectable to the external power source (such as an electricity outlet) via input circuitry or an interface such as an electrical power cable. Power circuitry 837 may also in certain embodiments be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

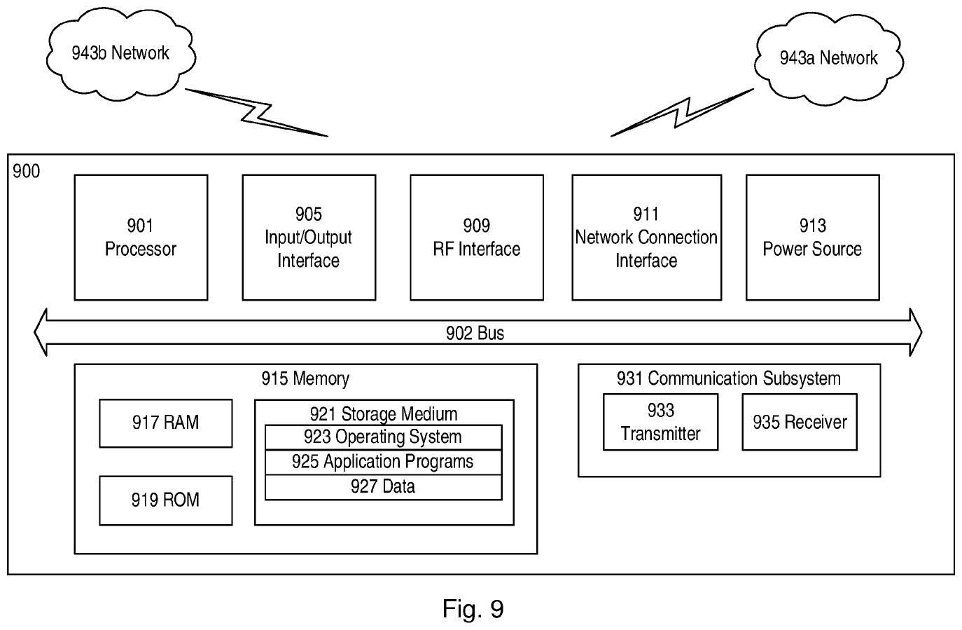

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 900 may be any UE identified by the 3^{rd} Generation Partnership Project (3GPP), including a NB-IoT UE, a machine type communication (MTC) UE, and/or an enhanced MTC (eMTC) UE. UE 900, as illustrated in FIG. 9, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 900 includes processing circuitry 901 that is operatively coupled to input/output interface 905, radio frequency (RF) interface 909, network connection interface 911, memory 915 including random access memory (RAM) 917, read-only memory (ROM) 919, and storage medium 921 or the like, communication subsystem 931, power source 933, and/or any other component, or any combination thereof. Storage medium 921 includes operating system 923, application program 925, and data 927. In other embodiments, storage medium 921 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 901 may be configured to process computer instructions and data. Processing circuitry 901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 901 may include two central processing units (CPUs). Data may be information in a form suitable for use by a computer.

In the depicted embodiment, input/output interface 905 may be configured to provide a communication interface to an input device, output device, or input and output device. UE 900 may be configured to use an output device via input/output interface 905. An output device may use the same type of interface port as an input device. For example, a USB port may be used to provide input to and output from UE 900. The output device may be a speaker, a sound card, a video card, a display, a monitor, a printer, an actuator, an emitter, a smartcard, another output device, or any combination thereof. UE 900 may be configured to use an input device via input/output interface 905 to allow a user to capture information into UE 900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 909 may be configured to provide a communication interface to RF components such as a transmitter, a receiver, and an antenna. Network connection interface 911 may be configured to provide a communication interface to network 943a. Network 943a may encompass wired and/or wireless networks such as a local-area network (LAN), a wide-area network (WAN), a computer network, a wireless network, a telecommunications network, another like network or any combination thereof. For example, network 943a may comprise a Wi-Fi network. Network connection interface 911 may be configured to include a receiver and a transmitter interface used to communicate with one or more other devices over a communication network according to one or more communication protocols, such as Ethernet, TCP/IP, SONET, ATM, or the like. Network connection interface 911 may implement receiver and transmitter functionality appropriate to the communication network links (e.g., optical, electrical, and the like). The transmitter and receiver functions may share circuit components, software or firmware, or alternatively may be implemented separately.

RAM 917 may be configured to interface via bus 902 to processing circuitry 901 to provide storage or caching of data or computer instructions during the execution of software programs such as the operating system, application programs, and device drivers. ROM 919 may be configured to provide computer instructions or data to processing circuitry 901. For example, ROM 919 may be configured to store invariant low-level system code or data for basic system functions such as basic input and output (I/O), startup, or reception of keystrokes from a keyboard that are stored in a non-volatile memory. Storage medium 921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 921 may be configured to include operating system 923, application program 925 such as a web browser application, a widget or gadget engine or another application, and data file 927. Storage medium 921 may store, for use by UE 900, any of a variety of various operating systems or combinations of operating systems.

Storage medium 921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 921 may allow UE 900 to access computer-executable instructions, application programs or the like, stored on transitory or non-transitory memory media, to off-load data, or to upload data. An article of manufacture, such as one utilizing a communication system may be tangibly embodied in storage medium 921, which may comprise a device readable medium.

In FIG. 9, processing circuitry 901 may be configured to communicate with network 943b using communication subsystem 931. Network 943a and network 943b may be the same network or networks or different network or networks. Communication subsystem 931 may be configured to include one or more transceivers used to communicate with network 943b. For example, communication subsystem 931 may be configured to include one or more transceivers used to communicate with one or more remote transceivers of another device capable of wireless communication such as another WD, UE, or base station of a radio access network (RAN) according to one or more communication protocols, such as IEEE 802.11, Code Division Multiplexing Access (CDMA), WCDMA, GSM, LTE, Universal Terrestrial Radio Access Network (UTRAN), WiMax, or the like. Each transceiver may include transmitter 933 and/or receiver 935 to implement transmitter or receiver functionality, respectively, appropriate to the RAN links (e.g., frequency allocations and the like). Further, transmitter 933 and receiver 935 of each transceiver may share circuit components, software or firmware, or alternatively may be implemented separately.

In the illustrated embodiment, the communication functions of communication subsystem 931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 931 may include cellular communication, Wi-Fi communication, Bluetooth communication, and GPS communication. Network 943b may encompass wired and/or wireless networks such as a local-area network (LAN), a wide-area network (WAN), a computer network, a wireless network, a telecommunications network, another like network or any combination thereof. For example, network 943b may be a cellular network, a Wi-Fi network, and/or a near-field network. Power source 913 may be configured to provide alternating current (AC) or direct current (DC) power to components of UE 900.

The features, benefits and/or functions described herein may be implemented in one of the components of UE 900 or partitioned across multiple components of UE 900. Further, the features, benefits, and/or functions described herein may be implemented in any combination of hardware, software or firmware. In one example, communication subsystem 931 may be configured to include any of the components described herein. Further, processing circuitry 901 may be configured to communicate with any of such components over bus 902. In another example, any of such components may be represented by program instructions stored in memory that when executed by processing circuitry 901 perform the corresponding functions described herein. In another example, the functionality of any of such components may be partitioned between processing circuitry 901 and communication subsystem 931. In another example, the non-computationally intensive functions of any of such components may be implemented in software or firmware and the computationally intensive functions may be implemented in hardware.

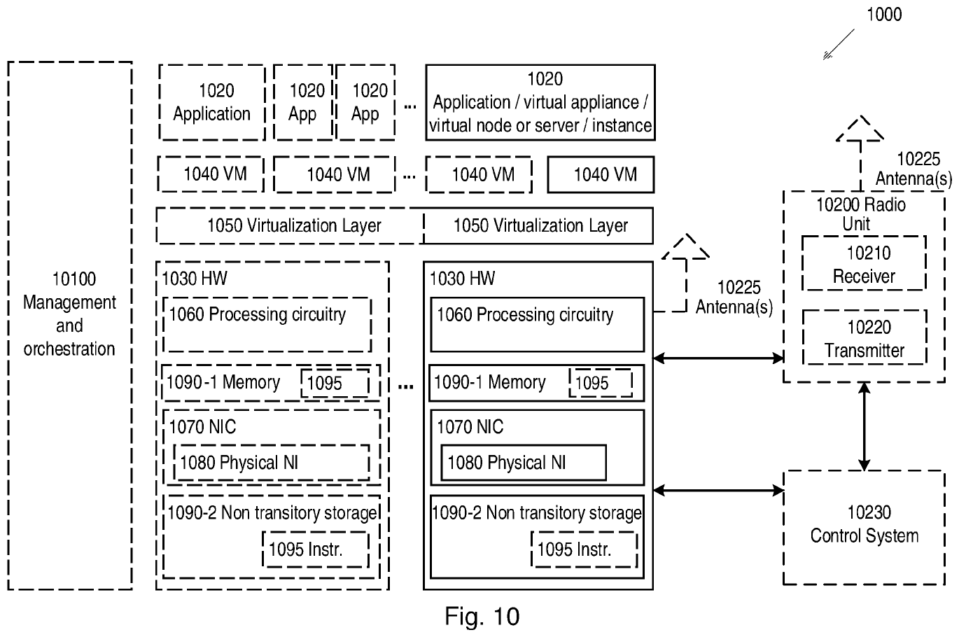

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030. Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000, comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features and/or benefits described in relation with some embodiments described herein.

Virtual machines 1040, comprise virtual processing, virtual memory, virtual networking or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g. such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1040 may be a software implementation of a physical machine that runs programs as if they were executing on a physical, non-virtualized machine. Each of virtual machines 1040, and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signalling can be effected with the use of control system 10230 which may alternatively be used for communication between the hardware nodes 1030 and radio units 10200.

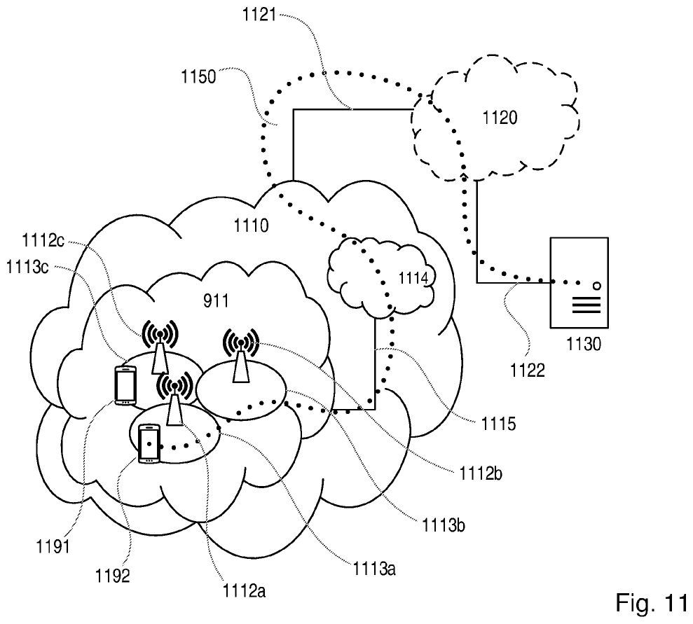

With reference to FIG. 11, in accordance with an embodiment, a communication system includes telecommunication network 1110, such as a 3GPP-type cellular network, which comprises access network 1111, such as a radio access network, and core network 1114. Access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

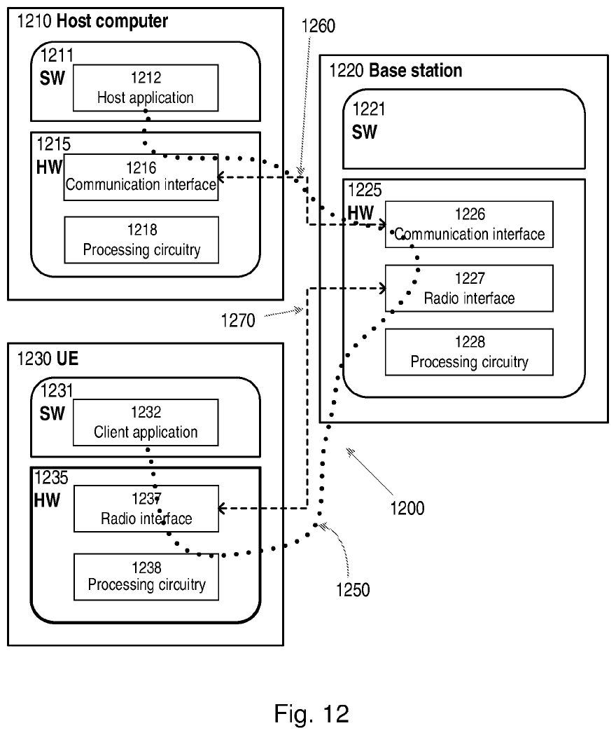

Example implementations, in accordance with an embodiment, of the UE, base station and host computer discussed in the preceding paragraphs will now be described with reference to FIG. 12. In communication system 1200, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may facilitate intra-DU rerouting of traffic under RLF and minimize packet losses and thereby provide benefits such as enhanced network load balancing capabilities as well as greater utilization of paths (i.e., paths terminating at all donor DUs under a donor CU) for the purposes of load balancing.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

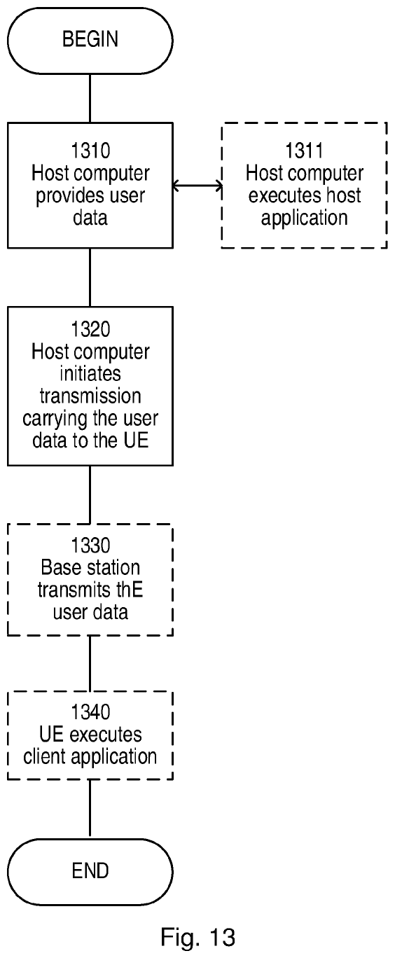

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

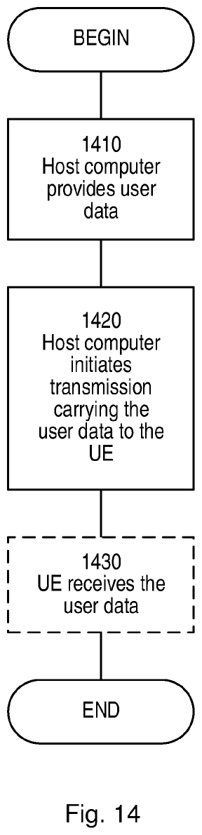

FIG. 14 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

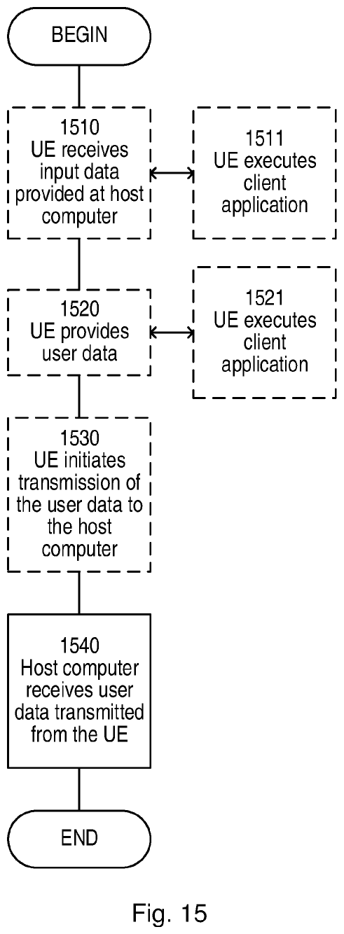

FIG. 15 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

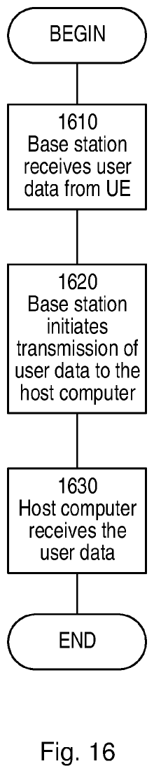

FIG. 16 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

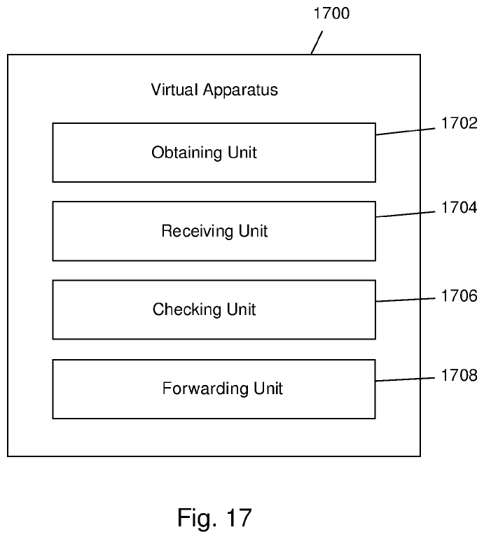

FIG. 17 illustrates a schematic block diagram of an apparatus 1700 in a wireless network (for example, the wireless network shown in FIG. 8). The apparatus may be implemented in network node (e.g., network node 860 shown in FIG. 8). More specifically, the apparatus may be implemented in a first donor DU in an IAB network, where the IAB network comprises a donor CU, a plurality of donor DUs including the first donor DU, and a plurality of IAB nodes, and where each IAB node is assigned an IP address and is under the domain of one or more donor DUs. Apparatus 1700 is operable to carry out the example methods described with reference to FIG. 5 and possibly any other processes or methods disclosed herein. It is also to be understood that the method of FIG. 5 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 1702, receiving unit 1704, checking unit 1706, forwarding unit 1708, and any other suitable units of apparatus 1700 to perform corresponding functions according one or more embodiments of the present disclosure.

As illustrated in FIG. 17, apparatus 1700 includes obtaining unit 1702, receiving unit 1704, checking unit 1706, and forwarding unit 1708. Obtaining unit 1702 is configured to obtain, for each of the plurality of IAB nodes under the domain of each donor DU in the plurality of donor DUs, a respective assigned IP address of the respective IAB node. Obtaining unit 1702 may be configured to obtain the respective assigned IP address from the donor CU.

Receiving unit 1704 is configured to receiving a rerouted packet.

Checking unit 1706 is configured to check whether a source IP address of the rerouted packet matches an assigned IP address of an IAB node under the domain of the first donor DU. Furthermore, checking unit 1706 is configured to check whether the source IP address of the rerouted packet matches an assigned IP address obtained by the donor DU if the source IP address of the rerouted packet does not match an assigned IP address of an IAB node under the domain of the first donor DU.

Forwarding unit 1708 is configured to forward the rerouted packet to an upper layer if the source IP address of the rerouted packet matches an assigned IP address obtained the donor DU.

In some embodiments, the apparatus 1700 may further comprise a dropping unit configured to drop the rerouted packet is if the source IP address of the rerouted packet does not match any obtained IP addresses.

In some embodiments, the apparatus 1700 may further comprise a removing unit configured to remove the BAP header of the rerouted packet.

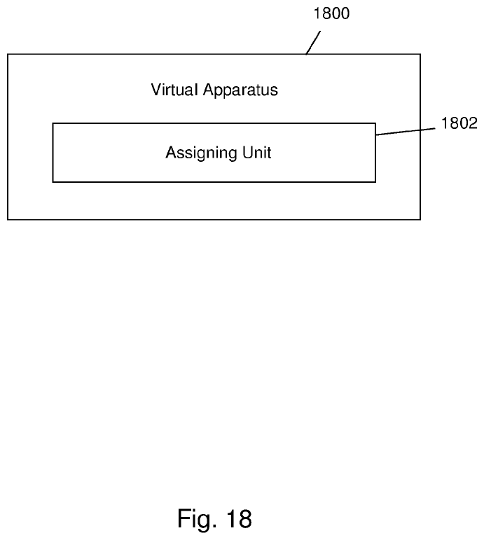

FIG. 18 illustrates a schematic block diagram of an apparatus 1800 in a wireless network (for example, the wireless network shown in FIG. 8). The apparatus may be implemented in a network node (e.g., network node 860 shown in FIG. 8). More specifically, the apparatus may be implemented in a donor CU in an IAB network, where the IAB network comprises the donor CU, a plurality of donor DUs, and a plurality of IAB nodes. Apparatus 1800 is operable to carry out the example methods described with reference to FIG. 6 and possibly any other processes or methods disclosed herein. It is also to be understood that the method of FIG. 6 is not necessarily carried out solely by apparatus 1800. At least some operations of the method can be performed by one or more other entities.

Virtual Apparatus 1800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause assigning unit 1802, and any other suitable units of apparatus 1800 to perform corresponding functions according one or more embodiments of the present disclosure.

As illustrated in FIG. 18, apparatus 1800 includes assigning unit 1802. Assigning unit 1802 is configured to assign a same BAP address to each of the plurality of donor DUs, and to assign a different BAP path ID for each path originating from an IAB node and terminating at one of the plurality of donor DUs. In some embodiments, each different BAP path ID may be a unique BAP path ID.

The apparatus 1800 may further comprise a sharing unit configured to share, for each of the plurality of IAB nodes under the domain of a donor DU, a respective assigned IP address of the respective IAB node to one or more other donor DUs.

The apparatus 1800 may further comprise a configuring unit configured to configure at least one of the plurality of IAB nodes to evaluate a level of congestion of an egress link of the respective IAB node. The configuring unit may also be configured to configure, for at least one of the plurality of IAB nodes, a threshold of radio measurements below which the IAB node is allowed to perform rerouting. The configuring unit may be configured to configure an IAB node to evaluate a level of congestion of an egress link of the IAB node by performing at least one of:
configuring the IAB node to receive flow control feedback from at least one of a parent node and a child node of the IAB node, the flow control feedback including a buffer size at the respective at least one of a parent node and a child node, and configuring the IAB node to determining whether the buffer size at the at least one of a parent node and a child node is over a predetermined threshold; and
configuring the IAB node to determine whether an elapsed time between reception of a data unit at the IAB node and transmission of the data unit to a parent node is over a predetermined threshold.

The apparatus may further comprise a configuring unit configured to configure, at one or more links, one or more dedicated BH RLC channels, where each of the one or more links is between an IAB node and a donor DU or between two IAB nodes, and where each of the one or more dedicated BH RLC channels is only used for forwarding rerouted traffic.

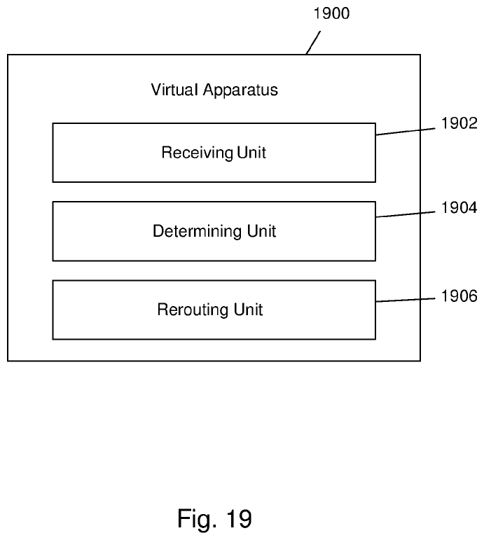

FIG. 19 illustrates a schematic block diagram of an apparatus 1900 in a wireless network (for example, the wireless network shown in FIG. 8). The apparatus may be implemented in a network node (e.g., network node 860 shown in FIG. 8). More specifically, the apparatus may be implemented in IAB node in an IAB network, where the IAB network comprises a donor CU, a plurality of donor DUs, and a plurality of IAB nodes including the IAB node. Apparatus 1900 is operable to carry out the example methods described with reference to FIG. 7 and possibly any other processes or methods disclosed herein. It is also to be understood that the method of FIG. 7 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1902, determining unit 1904, rerouting unit 1906, and any other suitable units of apparatus 1900 to perform corresponding functions according one or more embodiments of the present disclosure.

As illustrated in FIG. 19, apparatus 1900 includes receiving unit 1902, determining unit 1904, and rerouting unit 1906. Receiving unit 1902 is configured to receive a first packet, the first packet having a BAP routing ID in its header. The BAP routing ID comprises a BAP path ID and a BAP address, and the IAB node has its BH routing configuration.

Determining unit 1904 is configured to determine whether at least one of the following conditions apply to the received first packet:
the BAP path ID of the first packet is not present in the BH routing configuration of the IAB node;
the destination indicated by the BAP address of the received packet is not present in the BH routing configuration of the IAB node;
a link towards a next hop for the BAP routing ID of the first packet is unavailable, or the link is congested, or radio measurements for the link are below a predetermined threshold

Rerouting unit 1906 is configured to reroute the first packet upon determining unit 1904 determining that at least one of the conditions apply.

In some embodiments, the apparatus 1900 may further comprise a selecting unit configured to select a new BAP path ID among one or more BAP path IDs present in the BH routing configuration of the IAB node, and an assigning unit configured to assign the selected new BAP path ID to the first packet. In these embodiments, rerouting unit 1906 may be configured to reroute the first packet is performed based on the new BAP path ID.

In some embodiments, the selected new BAP path ID may be associated to the destination indicated by the BAP address of the first packet. In some embodiments, the selecting unit may be configured to perform the selection based on evaluation of at least one of: radio conditions of egress links associated with the one or more paths present in the BH routing configuration, load conditions of egress links associated with the one or more paths present in the BH routing configuration.

In some embodiments, the selecting unit may be configured to select a new BAP path ID by selecting a BAP path ID that corresponds to an egress link between the IAB node at which the first packet is received and an IAB node at a next hop.

In some embodiments, the apparatus 1900 may further comprise a retaining unit configured to retain the BAP address of the first packet after the assigning unit assigns the new selected BAP path ID.

In some embodiments, the apparatus 1900 may further comprise a setting unit configured to set, prior to rerouting unit 1906 rerouting the first packet, set one of the reserve bits in the BAP header of the first packet at a specific value to indicate that the first packet is rerouted. In some embodiments, the reserve bit may be a reroute bit, and the setting unit may be configured to set the reroute bit by setting the bit value to 1.

In some embodiments, the apparatus 1900 may further comprise an assigning unit configured to assign a special BAP routing ID to the received first packet upon determining unit 1904 determining at least one of the conditions apply to the received first packet. In these embodiments, the first packet is to be forwarded by a donor DU to an upper layer. In these embodiments, the special BAP routing ID may be pre-configured by the donor CU.

In some embodiments, the apparatus 1900 may further comprise a replacing unit configured to replace the BAP address of the first packet with a new BAP routing ID upon determining that the destination indicated by the BAP routing ID of the received first packet is not present in the BH routing configuration of the IAB node. The new BAP routing ID may indicate a destination that is included in the BH routing configuration of the IAB node.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following numbered statements set out embodiments of the disclosure.

### Embodiments

1. A method of configuring an Integrated Access Backhaul (IAB) network, wherein the IAB network comprises a donor central unit (CU), a plurality of donor distributed units (DUs), and a plurality of IAB nodes, wherein the plurality of donor DUs are configured and/or controlled by the donor CU, and wherein the method comprises:
   assigning, by the donor CU, a same Backhaul Adaptation Protocol (BAP) address to each of the plurality of donor DUs; and
   assigning, by the donor CU, for each path originating from an IAB node and terminating at one of the plurality of donor DUs, a different BAP path identity (ID).
2. The method of embodiment 1, wherein each different BAP path ID is a unique BAP path ID.
3. The method of embodiment 1 or embodiment 2, wherein the donor CU is a first donor CU, and the plurality of donor DUs is a first plurality of donor DUs, wherein the IAB network further comprises a second donor CU and a second plurality of donor DUs, the second plurality of donor DUs being configured and/or controlled by the second donor CU, and the method further comprises:
   assigning, by the second donor CU, a same BAP address to each of the second plurality of donor DUs; and
   assigning, by the second donor CU, for each path originating from an IAB node and terminating at one of the second plurality of donor DUs, a different BAP path ID.
4. The method of any one of the preceding embodiments, further comprising the steps:
   sharing, for each of the plurality of IAB nodes under the domain of a donor DU, a respective assigned IP address of the respective IAB node to one or more other donor DUs, wherein the sharing is performed by the donor CU;
   receiving a rerouted packet at a donor DU;
   checking, by the donor DU at which the rerouted packet is received, whether the source IP address of the rerouted packet matches an IP address of an IAB node under the domain of the donor DU at which the rerouted packet is received;
   if the source IP address of the rerouted packet does not match an IP address of an IAB node under the domain of the donor DU at which the rerouted packet is received, checking whether the source IP address of the rerouted packet matches an IP address shared by the donor CU to the donor DU at which the rerouted packet is received; and
   forwarding the rerouted packet to an upper layer if the source IP address of the rerouted packet matches an IP address shared by the donor CU to the donor DU at which the rerouted packet is received.
5. The method according to embodiment 4, further comprising the step:
   dropping the rerouted packet if the source IP address of the rerouted packet does not match any IP addresses shared by the donor CU.
6. The method according to embodiment 4 or embodiment 5, further comprising the step:
   removing, at the donor DU at which the rerouted packet is received, the BAP header of the rerouted packet.
7. The method according to any one of embodiments 4-6, wherein prior to the step of receiving a rerouted packet at a donor DU, the method further comprises the step of rerouting the packet, wherein the step of rerouting the packet comprises:
   receiving a first packet at an IAB node, wherein the first packet has a BAP routing ID in its header, wherein the BAP routing ID comprises a BAP path ID and a BAP address, and wherein the IAB node has its Backhaul (BH) routing configuration
   determining, at the IAB node at which the first packet is received, whether at least one of the following conditions apply to the received first packet:
      the BAP path ID of the first packet is not present in the BH routing configuration of the IAB node at which the first packet is received;
      the destination indicated by the BAP address of the received packet is not present in the BH routing configuring of the IAB node at which the first packet is received;
      a link towards a next hop for the BAP routing ID of the first packet is broken, or the link is congested, or radio measurements for the link are below a predetermined threshold; and
   rerouting the first packet upon determining that at least one of the conditions apply.
8. The method according to embodiment 7, further comprising the step:
   configuring, by the donor CU, the IAB node at which the first packet is received to evaluate a level of congestion of an egress link of the IAB node,
wherein determining whether the link towards the next hop for the BAP routing ID of the first packet is congested is based on the evaluation.
9. The method according to embodiment 7 or embodiment 8, further comprising the steps:
   configuring, by the donor CU, the IAB node at which the first packet is received to evaluate radio conditions of an egress link of the IAB node; and
   configuring, by the donor CU, a threshold of radio measurements below which the IAB node is allowed to perform rerouting.
10. The method according to any one of embodiments 7-9, further comprising the steps:
   selecting, by the IAB node at which the first packet is received, a new BAP path ID among one or more BAP path IDs present in the BH routing configuration of the IAB node, wherein the selected new BAP path ID is associated to the destination indicated by the BAP address of the first packet; and
   assigning the selected new BAP path ID to the first packet,
wherein rerouting the first packet is performed based on the new BAP path ID.
11. The method according to embodiment 10, wherein selecting a new BAP path ID comprises selecting a BAP path ID that corresponds to an egress link between the IAB node at which the first packet is received and an IAB node at a next hop.
12. The method according to embodiment 10 or embodiment 11, further comprising the step:
   retaining the BAP address of the first packet after assigning the new selected BAP path ID.
13. The method according to any one of embodiments 7-9, further comprising the steps:
   selecting, by the IAB node at which the first packet is received, a new BAP path ID among one or more BAP path IDs present in the BH routing configuration of the IAB node, wherein the selection is based on evaluation of at least one of: radio conditions of egress links associated with the one or more paths present in the BH routing configuration, load conditions of egress links associated with the one or more paths present in the BH routing configuration; and
   assigning the selected new BAP path ID to the first packet,
wherein rerouting the first packet is performed based on the new BAP path ID.
14. The method according to embodiment 13, further comprising the step:
   retaining the BAP address of the first packet after assigning the new selected BAP path ID.
15. The method according to any one of the preceding embodiments, further comprising the step:
   configuring, at one or more links, one or more dedicated Backhaul (BH) Radio Link Control (RLC) channels, wherein each of the one or more links is between an IAB node and a donor DU or between two IAB nodes, and wherein each of the one or more dedicated BH RLC channels is only used for forwarding rerouted traffic.
16. The method according to any one of the preceding embodiments, further comprising the step:
   setting, at an IAB node at which a packet is to be rerouted, one of the reserve bits in the BAP header of the packet at a specific value to indicate that the packet is rerouted, wherein the setting is performed prior to forwarding the packet.
17. The method according to embodiment 16, wherein the reserve bit is a reroute bit, and setting the reroute bit at the IAB node at which the packet is to be rerouted comprises setting the bit value to 1.
18. The method according to any one of the preceding embodiments, further comprising the steps:
   receiving, at a first IAB node of the plurality of IAB nodes, a packet with a BAP routing ID in its header, wherein the BAP routing ID comprises a BAP path ID and a BAP address, and wherein the IAB node has its Backhaul (BH) routing configuration;
   determining whether at least one of the following conditions apply to the received packet:
      the BAP path ID of the received packet is not present in the BH routing configuration of the first IAB node;
      the destination indicated by the BAP address of the received packet is not present in the BH routing configuring of the first IAB node; and
      a link towards a next hop for the BAP routing ID of the received packet is broken, or the link is congested, or radio measurements for the link are below a predetermined threshold;
   assigning, by the first IAB node, a special BAP path ID to the received packet upon determining at least one of the conditions apply to the received packet;
   receiving the packet with the assigned special BAP path ID at a second IAB node or a donor DU; and
   forwarding the packet with the assigned special BAP path ID by the second IAB node according to the BAP address of the packet and the BH routing configuration associated with the destination of the BAP address of the packet, or forwarding the packet with the assigned special BAP path ID by the donor DU.
19. The method according to embodiment 18, wherein the special BAP path ID is pre-configured by the donor CU.
20. The method according to embodiment 18 or embodiment 19, further comprising the step:
   replacing, by the first IAB node, the BAP address of the packet received at the first IAB node with a new BAP address upon determining that the destination indicated by the BAP address of the received packet is not present in the BH routing configuring of the first IAB node, wherein the new BAP address indicates a destination that is included in the BH routing configuration of the first IAB node.
21. A method of configuring an Integrated Access Backhaul (IAB) network, wherein the IAB network comprises a donor central unit (CU), a plurality of donor distributed units (DUs), and a plurality of IAB nodes, wherein the plurality of donor DUs are configured and/or controlled by the donor CU, wherein each of the plurality of IAB nodes is assigned an IP address and is under the domain of one or more of the plurality of donor DUs, and wherein the method comprises:
   sharing, for each of the plurality of IAB nodes under the domain of a donor DU, a respective assigned IP address of the respective IAB node to one or more other donor DUs, wherein the sharing is performed by the donor CU;
   receiving a rerouted packet at a donor DU;
   checking, by the donor DU at which the rerouted packet is received, whether the source IP address of the rerouted packet matches an IP address of an IAB node under its domain;
   if the source IP address of the rerouted packet does not match an IP address of an IAB node under the domain of the donor DU at which the rerouted packet is received, checking whether the source IP address of the rerouted packet matches an IP address shared by the donor CU to the donor DU at which the rerouted packet is received; and
   forwarding the rerouted packet to an upper layer if the source IP address of the rerouted packet matches an IP address shared by the donor CU to the donor DU at which the rerouted packet is received.
22. The method according to embodiment 21, further comprising the step:
   dropping the rerouted packet if the source IP address of the rerouted packet does not match any IP addresses shared by the donor CU.
23. The method according to embodiment 21 or embodiment 22, further comprising the step:
   configuring, at one or more links, one or more dedicated Backhaul (BH) Radio Link Control (RLC) channels, wherein each of the one or more links is between an IAB node and a donor DU or between two IAB nodes, and wherein each of the one or more dedicated BH RLC channels is only used for forwarding rerouted traffic.
24. The method according to any one of embodiments 21-23, further comprising the step:
   setting, at an IAB node at which a packet is to be rerouted, one of the reserve bits in the BAP header of the packet at a specific value to indicate that the packet is rerouted, wherein the setting is performed prior to forwarding the packet.
25. The method according to embodiment 24, wherein the reserve bit is a reroute bit, and setting the reroute bit at the IAB node at which the packet is to be rerouted comprises setting the bit value to 1.
26. The method according to any one of embodiments 21-25, further comprising the steps:
   removing, at the donor DU at which the rerouted packet is received, the BAP header of the rerouted packet.
27. The method according any one of embodiments 21-26, further comprising the steps:
   receiving, at a first IAB node of the plurality of IAB nodes, a packet with a BAP routing ID in its header, wherein the BAP routing ID comprises a BAP path ID and a BAP address, and wherein the IAB node has its Backhaul (BH) routing configuration;
   determining whether at least one of the following conditions apply to the received packet:
   the BAP path ID of the received packet is not present in the BH routing configuration of the first IAB node;
      the destination indicated by the BAP address of the received packet is not present in the BH routing configuring of the first IAB node; and
      a link towards a next hop for the BAP routing ID of the received packet is broken, or the link is congested, or radio measurements for the link are below a predetermined threshold;
      assigning, by the first IAB node, a special BAP path ID to the received packet upon determining at least one of the conditions apply to the received packet;
      receiving the packet with the assigned special BAP path ID at a second IAB node or a donor DU; and
   forwarding the packet with the assigned special BAP path ID by the second IAB node according to the BAP address of the packet and the BH routing configuration associated with the destination of the BAP address of the packet, or forwarding the packet with the assigned special BAP path ID by the donor DU.
28. The method according to embodiment 27, wherein the special BAP path ID is pre-configured by the donor CU.
29. The method according to embodiment 27 or embodiment 28, further comprising the step:
   replacing, by the first IAB node, the BAP address of the packet received at the first IAB node with a new BAP address upon determining that the destination indicated by the BAP address of the received packet is not present in the BH routing configuring of the first IAB node, wherein the new BAP address indicates a destination that is included in the BH routing configuration of the first IAB node.
30. The method according to any one of embodiments 21-29, wherein prior to the step receiving a rerouted packet at a donor DU, the method further comprises the step of rerouting the packet, wherein the step of rerouting the packet comprises:
   receiving a first packet at an IAB node, wherein the first packet has a BAP routing ID in its header, wherein the BAP routing ID comprises a BAP path ID and a BAP address, and wherein the IAB node has its Backhaul (BH) routing configuration
   determining, at the IAB node at which the first packet is received, whether at least one of the following conditions apply to the received first packet:
      the BAP path ID of the first packet is not present in the BH routing configuration of the IAB node at which the first packet is received;
      the destination indicated by the BAP address of the received packet is not present in the BH routing configuring of the IAB node at which the first packet is received;
      a link towards a next hop for the BAP routing ID of the first packet is broken, or the link is congested, or radio measurements for the link are below a predetermined threshold; and
   rerouting the first packet upon determining that at least one of the conditions apply.
31. The method according to embodiment 30, further comprising the step:
   configuring, by the donor CU, the IAB node at which the first packet is received to evaluate a level of congestion of an egress link of the IAB node,
wherein determining whether the link towards the next hop for the BAP routing ID of the first packet is congested is based on the evaluation.
32. The method according to embodiment 30 or embodiment 31, further comprising the steps:
   configuring, by the donor CU, the IAB node at which the first packet is received to evaluate radio conditions of an egress link of the IAB node; and
   configuring, by the donor CU, a threshold of radio measurements below which the IAB node is allowed to perform rerouting.
33. The method according any one of embodiments 30-32, further comprising the steps:
   selecting, by the IAB node at which the first packet is received, a new BAP path ID among one or more BAP path IDs present in the BH routing configuration of the IAB node, wherein the selected new BAP path ID is associated to the destination indicated by the BAP address of the first packet; and
   assigning the selected new BAP path ID to the first packet,
wherein rerouting the first packet is performed based on the new BAP path ID.
34. The method according to embodiment 33, wherein selecting a new BAP path ID comprises selecting a BAP path ID that corresponds to an egress link between the IAB node at which the first packet is received and an IAB node at a next hop.
35. The method according to embodiment 33 or embodiment 34, further comprising the step:
   retaining the BAP address of the first packet after assigning the new selected BAP path ID.
36. The method according to any one of embodiments 30-32, further comprising the steps:
   selecting, by the IAB node at which the first packet is received, a new BAP path ID among one or more BAP path IDs present in the BH routing configuration of the IAB node, wherein the selection is based on evaluation of at least one of: radio conditions of egress links associated with the one or more paths present in the BH routing configuration, load conditions of egress links associated with the one or more paths present in the BH routing configuration; and
   assigning the selected new BAP path ID to the first packet,
wherein rerouting the first packet is performed based on the new BAP path ID.
37. The method according to embodiment 36, further comprising the step:
   retaining the BAP address of the first packet after assigning the new selected BAP path ID.

1. A method performed by a first donor distributed unit (DU) in an integrated access backhaul (IAB) network, wherein the IAB network comprises a donor central unit (CU) a plurality of donor DUs including the first donor DU, and a plurality of IAB nodes, wherein each of the plurality of IAB nodes is assigned an IP address and is under the domain of one or more of the plurality of donor DUs, and wherein the method comprises:
obtaining for each of the plurality of IAB nodes under the domain of each donor DU in the plurality of donor DUs, a respective assigned IP address of the respective IAB node;
receiving a rerouted packet;
checking whether a source IP address of the rerouted packet matches an assigned IP address of an IAB node under the domain of the first donor DU;
if the source IP address of the rerouted packet does not match an assigned IP address of an IAB node under the domain of the first donor DU, checking whether the source IP address of the rerouted packet matches an assigned IP address obtained by the donor DU; and
if the source IP address of the rerouted packet matches an assigned IP address obtained the donor DU, forwarding the rerouted packet to an upper layer.

2. The method according to claim 1, wherein obtaining a respective assigned IP address of the respective IAB node comprises obtaining the respective assigned IP address from the donor CU.

3. The method according to claim 1, further comprising dropping the rerouted packet if the source IP address of the rerouted packet does not match any obtained IP addresses.

4. The method according to claim 1, further comprising removing a Backhaul Adaptation Protocol (BAP) header of the rerouted packet.

5. A method performed by a donor central unit (CU) in an integrated access backhaul (IAB) network, wherein the IAB network comprises the donor CU, a plurality of donor distributed units (DUs), and a plurality of IAB nodes, and wherein the method comprises:
assigning a same Backhaul Adaptation Protocol (BAP) address to each of the plurality of donor DUs; and
assigning for each path originating from an IAB node and terminating at one of the plurality of donor DUs, a different BAP path identity, ID.

6. The method according to claim 5, wherein each different BAP path ID is a unique BAP path ID.

7. The method according to claim 5, further comprising:
sharing, for each of the plurality of IAB nodes under the domain of a donor DU, a respective assigned IP address of the respective IAB node to one or more other donor DUs.

8. The method according to claim 5, further comprising performing at least one of:
configuring at least one of the plurality of IAB nodes to evaluate a level of congestion of an egress link of the respective IAB node; and
configuring, for at least one of the plurality of IAB nodes, a threshold of radio measurements below which the IAB node is allowed to perform rerouting.

9. The method according to claim 8, wherein configuring an IAB node to evaluate a level of congestion of an egress link of the IAB node comprises performing at least one of:
configuring the IAB node to receive flow control feedback from at least one of a parent node and a child node of the IAB node, wherein the flow control feedback includes a buffer size at the respective at least one of a parent node and a child node, and configuring the IAB node to determining whether the buffer size at the at least one of a parent node and a child node is over a predetermined threshold; and
configuring the IAB node to determine whether an elapsed time between reception of a data unit at the IAB node and transmission of the data unit to a parent node is over a predetermined threshold.

10. The method according to claim 5, further comprising:
configuring, at one or more links, one or more dedicated Backhaul (BH) Radio Link Control (RLC) channels, wherein each of the one or more links is between an IAB node and a donor DU or between two IAB nodes, and wherein each of the one or more dedicated BH RLC channels is only used for forwarding rerouted traffic.

11. A method performed by an Integrated Access Backhaul (IAB) node in an IAB network, wherein the IAB network comprises a donor central unit (CU), a plurality of donor distributed units (DUs), and a plurality of IAB nodes including the IAB node, and wherein the method comprises:
receiving a first packet, wherein the first packet has a Backhaul Adaptation Protocol (BAP) routing ID in its header, wherein the BAP routing ID comprises a BAP path ID and a BAP address, and wherein the IAB node has its Backhaul (BH) routing configuration
determining whether at least one of the following conditions apply to the received first packet:
the BAP path ID of the first packet is not present in the BH routing configuration of the IAB node;
the destination indicated by the BAP address of the received packet is not present in the BH routing configuration of the IAB node;
a link towards a next hop for the BAP routing ID of the first packet is unavailable, or the link is congested, or radio measurements for the link are below a predetermined threshold; and
rerouting the first packet upon determining that at least one of the conditions apply.

12. The method according to claim 11, further comprising:
selecting a new BAP path ID among one or more BAP path IDs present in the BH routing configuration of the IAB node, wherein the selected new BAP path ID is associated to the destination indicated by the BAP address of the first packet; and
assigning the selected new BAP path ID to the first packet,
wherein rerouting the first packet is performed based on the new BAP path ID.

13. The method according to claim 12, wherein selecting a new BAP path ID comprises selecting a BAP path ID that corresponds to an egress link between the IAB node at which the first packet is received and an IAB node at a next hop.

14. The method according to claim 11, further comprising
selecting a new BAP path ID among one or more BAP path IDs present in the BH routing configuration of the IAB node, wherein the selection is based on evaluation of at least one of: radio conditions of egress links associated with the one or more paths present in the BH routing configuration, load conditions of egress links associated with the one or more paths present in the BH routing configuration; and
assigning the selected new BAP path ID to the first packet,
wherein rerouting the first packet is performed based on the new BAP path ID.

15. The method according to claim 12, further comprising retaining the BAP address of the first packet after assigning the new selected BAP path ID.

16. The method according to claim 11, further comprising, prior to rerouting the first packet, setting one of the reserve bits in the BAP header of the first packet at a specific value to indicate that the first packet is rerouted.

17. The method according to claim 16, wherein the reserve bit is a reroute bit, and setting the reroute bit comprises setting the bit value to 1.

18. The method according to claim 11, further comprising assigning a special BAP routing ID to the received first packet upon determining at least one of the conditions apply to the received first packet, wherein the first packet is to be forwarded by a donor DU to an upper layer.

19. The method according to claim 18, wherein the special BAP routing ID is pre-configured by the donor CU.

20. The method according to claim 11, further comprising replacing the BAP address of the first packet with a new BAP routing ID upon determining that the destination indicated by the BAP routing ID of the received first packet is not present in the BH routing configuration of the IAB node, wherein the new BAP routing ID indicates a destination that is included in the BH routing configuration of the IAB node.

21-31. (canceled)
